(19) United States
(12) Patent Application Publication
(10) Pub. No.: US 2026/0369111 A1
(43) Pub. Date: Nov. 19, 2026

(54) DATASET ARCHITECTURE FOR SAFETY EVALUATION OF AUTONOMOUS OR SEMI-AUTONOMOUS SYSTEMS AND APPLICATIONS

(71) Applicant: NVIDIA Corporation, Santa Clara, CA (US)

(72) Inventors: Kenny Chowdhary, Hercules, CA (US); Mark Koren, San Jose, CA (US); Carl Johan Zanden, Vallda (SE); Hans Jonas Nilsson, Los Gatos, CA (US); Michael Cox, Menlo Park, CA (US); Sever Ioan Topan, San Francisco, CA (US)

(21) Appl. No.: 19/210,258

(22) Filed: May 16, 2025

(51) Int. Cl. G07C 5/08; G05B 13/02

(52) U.S. Cl. CPC G07C 5/0841; G05B 13/0265

(57) ABSTRACT

In various examples, test datasets for validating the performance of a machine (e.g., an autonomous or semi-autonomous machine or vehicle) in safety-critical scenarios may be generated based on defined safety goals and/or anticipated real-world operating conditions. For instance, a system(s) may use failure analysis techniques to determine a quantity of test data required to prove whether a machine meets a certain safety goal. In some examples, the system(s) may use models indicating anticipated machine usage to determine a target distribution for the quantity of the test data across various real-world conditions. Based at least on the quantity and target distribution, the system(s) may obtain test data (e.g., sensor recordings, simulation recordings, etc.) corresponding to specific driving scenarios associated with the safety goals. The test data and corresponding ground truth may then be used during safety tests to evaluate the performance of the machine with respect to the safety goal.

### BACKGROUND

Autonomous and semi-autonomous machines may undergo extensive testing to evaluate their performance under a variety of safety-critical conditions. For instance, an autonomous or semi-autonomous vehicle may be required to complete a variety of tests to assess how the vehicle—including subsystems and/or components of the vehicle—responds to different situations, such as avoiding collisions, detecting objects, responding to dynamic obstacles, or navigating structured and unstructured environments. In some examples, this testing may include replaying previously recorded sensor data, operating the system in simulated environments, or analyzing behavior of the machines during real-world deployments.

However, conventional systems and methods for generating test datasets may present several challenges when used to support safety evaluations. For example, conventional systems may not statistically structure their test datasets to validate whether autonomous or semi-autonomous systems meet defined safety objectives, which may result in overrepresentation of common conditions and/or underrepresentation of safety-critical edge cases. Additionally, the test scenarios included in test datasets generated using conventional systems and methods may not statistically reflect how the system is expected to operate after deployment, including variations in geography, environmental conditions, and/or usage patterns. Furthermore, the conventional systems and methods may generate test datasets that overlap with training datasets, which may lead to biased assessments and reduce the reliability of performance evaluations.

### SUMMARY

Embodiments of the present disclosure relate to a dataset architecture for safety evaluation of autonomous or semi-autonomous systems and applications. Systems and methods are disclosed that may translate safety goals of a machine into one or more test datasets (also referred to herein as “safety test datasets”) that may be used to evaluate the performance of the machine—including subsystems or components of the machine—with respect to the safety goals. For instance, a system(s) may use failure analysis techniques to determine a quantity of test data required to prove whether a machine meets a certain safety goal. In some examples, the system(s) may use models indicating anticipated machine usage to determine a target distribution for the quantity of the test data across various real-world conditions. Based at least on the quantity and target distribution, the system(s) may obtain test data (e.g., sensor recordings, simulation recordings, etc.) corresponding to specific driving scenarios associated with the safety goals. The test data and corresponding ground truth may then be used during safety tests to evaluate the performance of the machine with respect to the safety goal.

In contrast to conventional systems, the systems and methods of the present disclosure, in some embodiments, may programmatically derive safety test datasets by translating high-level safety goals into quantifiable dataset requirements through structured fault tree analysis. For instance, by using operational design domain (ODD) modeling and real-world driving profiles informed by end-user telemetry data, the disclosed systems and methods may ensure that test data is distributed according to realistic exposure scenarios, rather than overrepresenting benign conditions or underrepresenting edge cases. Additionally, the systems and methods of the present disclosure may maintain the safety test datasets as private sets—geofenced and access-restricted—to prevent contamination from training data and mitigate bias during validation. As a result, the systems and methods of the present disclosure may offer a principled, scalable, and statistically grounded framework for dataset generation, enabling more reliable, objective, and reproducible safety performance evaluations of autonomous or semi-autonomous systems across various deployment contexts.

### BRIEF DESCRIPTION OF THE DRAWINGS

The present systems and methods for a dataset architecture for safety evaluation of autonomous or semi-autonomous systems and applications are described in detail below with reference to the attached drawing figures, wherein:

FIG. 1 is a system-level data flow diagram illustrating an example of a process for generating and using a safety test dataset to evaluate performance of a machine with respect to one or more safety goals, in accordance with some embodiments of the present disclosure;

FIG. 2 illustrates an example of a process for performing a failure analysis, in accordance with some embodiments of the present disclosure;

FIG. 3 illustrates an example of a process for determining types of driving scenarios for evaluating safety goals, in accordance with some embodiments of the present disclosure;

FIG. 4 illustrates an example of a process for determining a quantity of test data for evaluating safety goals, in accordance with some embodiments of the present disclosure;

FIG. 5 illustrates an example of a process for generating ground truth labeling specifications for test data, in accordance with some embodiments of the present disclosure;

FIG. 6 illustrates an example of a process for determining a target distribution for test data across anticipated driving conditions, in accordance with some embodiments of the present disclosure;

FIG. 7A illustrates an example of a process for obtaining test data for a safety test dataset from one or more databases storing sensor data, in accordance with some embodiments of the present disclosure;

FIG. 7B illustrates an example of a process for obtaining test data for a safety test dataset by deploying one or more machines to generate sensor data, in accordance with some embodiments of the present disclosure;

FIG. 7C illustrates an example of a process for generating synthetic data to use as test data for a safety test dataset, in accordance with some embodiments of the present disclosure;

FIG. 8 illustrates an example of a process for generating ground truth data corresponding to test data, in accordance with some embodiments of the present disclosure;

FIG. 9 is a flow diagram illustrating an example of a method for generating a safety test dataset, in accordance with some embodiments of the present disclosure;

FIG. 10 is a flow diagram illustrating an example of a method for obtaining test data for a safety test dataset, in accordance with some embodiments of the present disclosure;

FIG. 11A is an example of sensor locations having corresponding fields of view or sensory fields for example autonomous or semi-autonomous machines, in accordance with at least some embodiments of the present disclosure;

FIG. 11B is an illustration of an example of component and sensor locations on an autonomous or semi-autonomous vehicle, in accordance with at least some embodiments of the present disclosure;

FIG. 11C is a block diagram of an example system architecture for an autonomous or semi-autonomous vehicle, robot, and/or other machine type, in accordance with at least some embodiments of the present disclosure;

FIG. 11D is a block diagram of an example architecture of a computing system—such as a system-on-a-chip (SoC)—in accordance with at least some embodiments of the present disclosure;

FIG. 11E is a system diagram for communication between cloud-based server(s) and an example autonomous or semi-autonomous vehicle, robot, and/or other machine type, in accordance with at least some embodiments of the present disclosure;

FIG. 12 is a system diagram illustrating a three computer ecosystem, including a computing system for generating or creating artificial intelligence (AI)—such as AI training and validation data, a computing system for training artificial intelligence, and a computing system deploying the AI at the edge, in accordance with at least some embodiments of the present disclosure;

FIG. 13 is a block diagram of an example computing system for generative artificial intelligence (AI), in accordance with at least some embodiments of the present disclosure; and

FIG. 14 is a block diagram of an example computing device, in accordance with at least some embodiments of the present disclosure.

### DETAILED DESCRIPTION

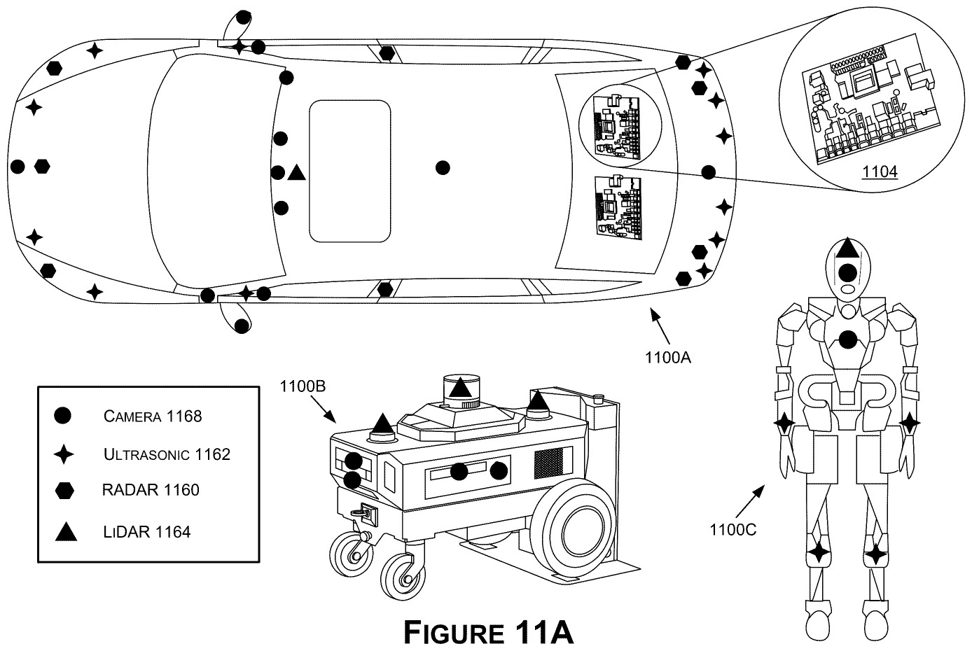

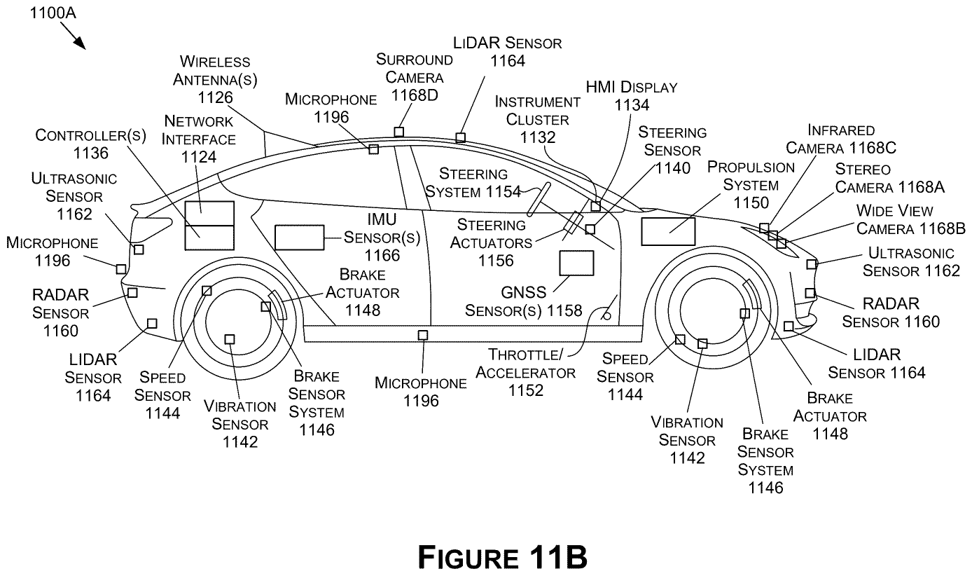

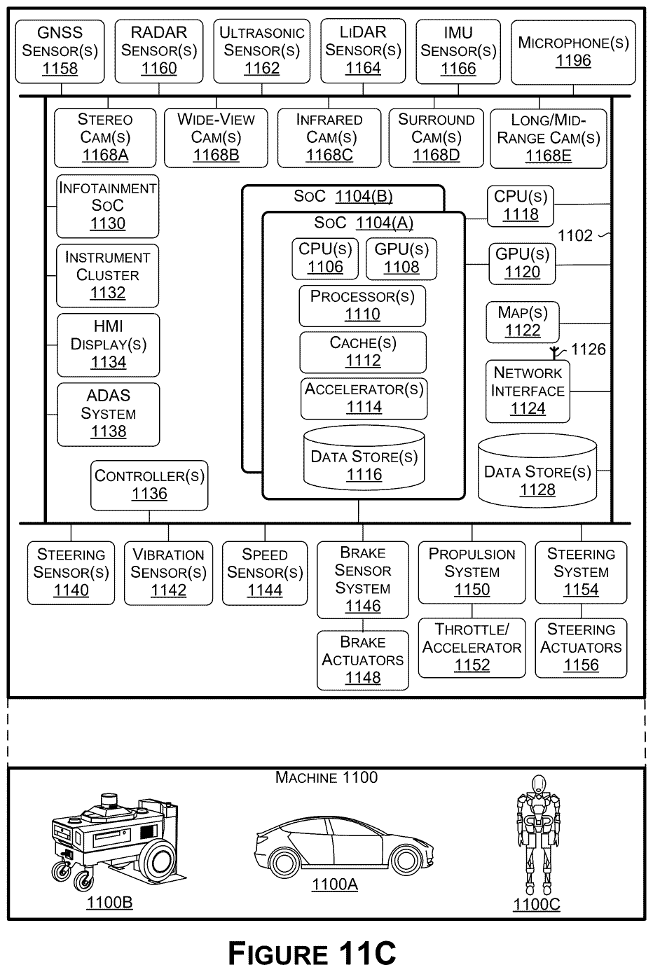

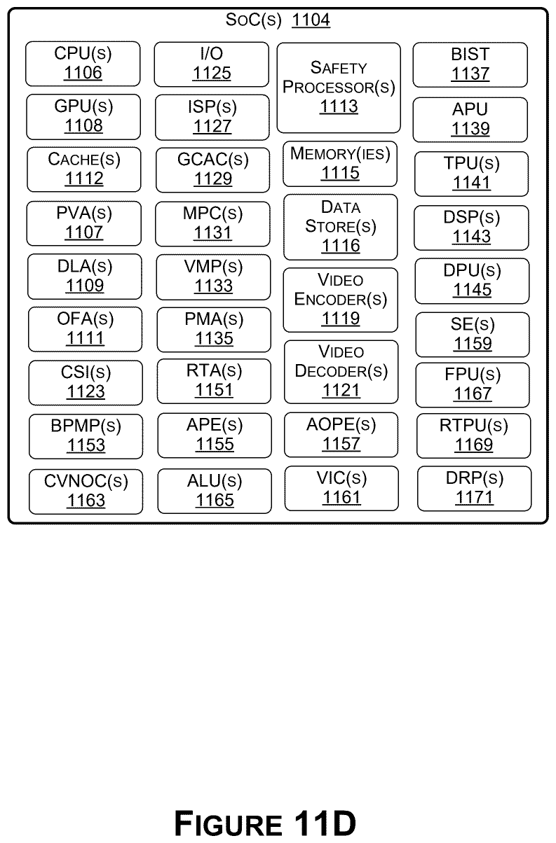

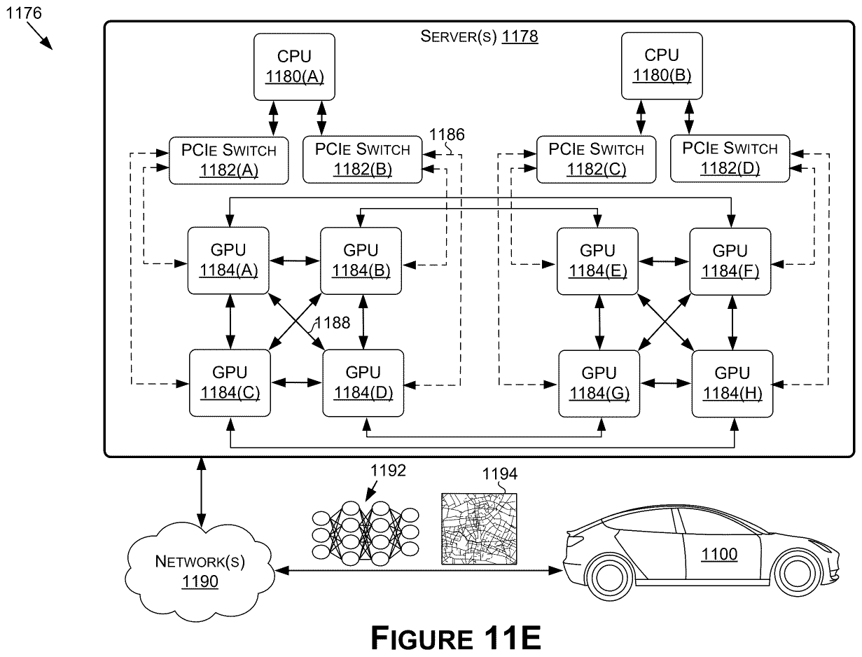

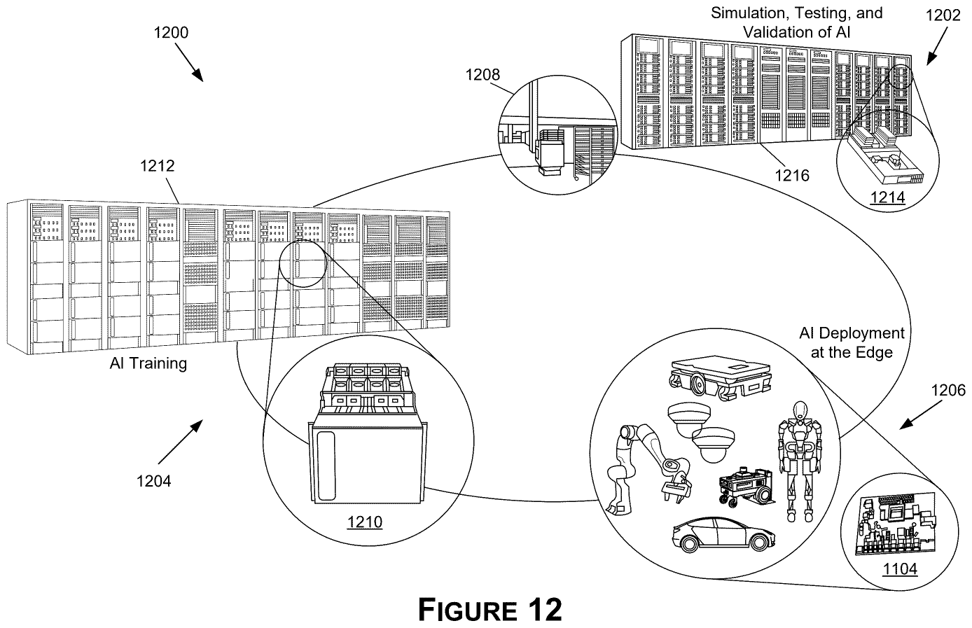

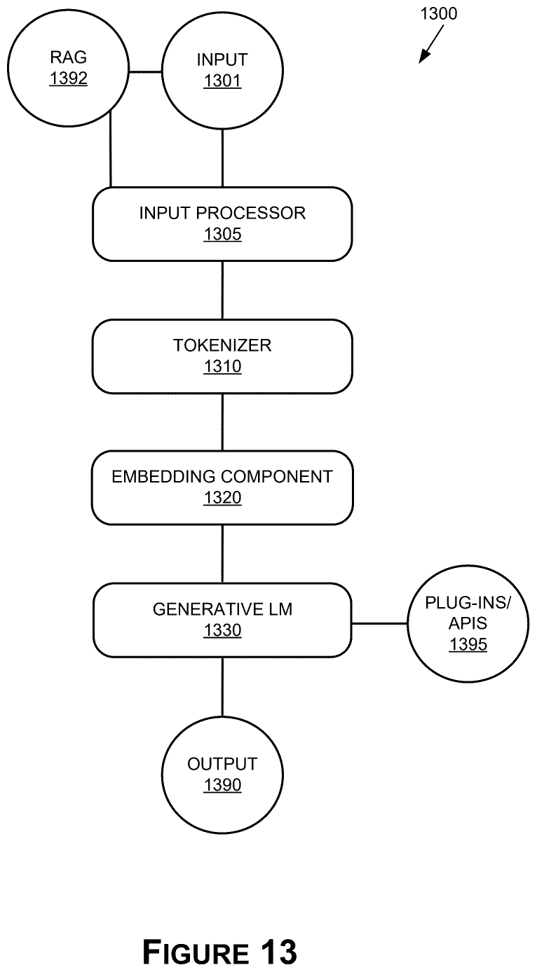

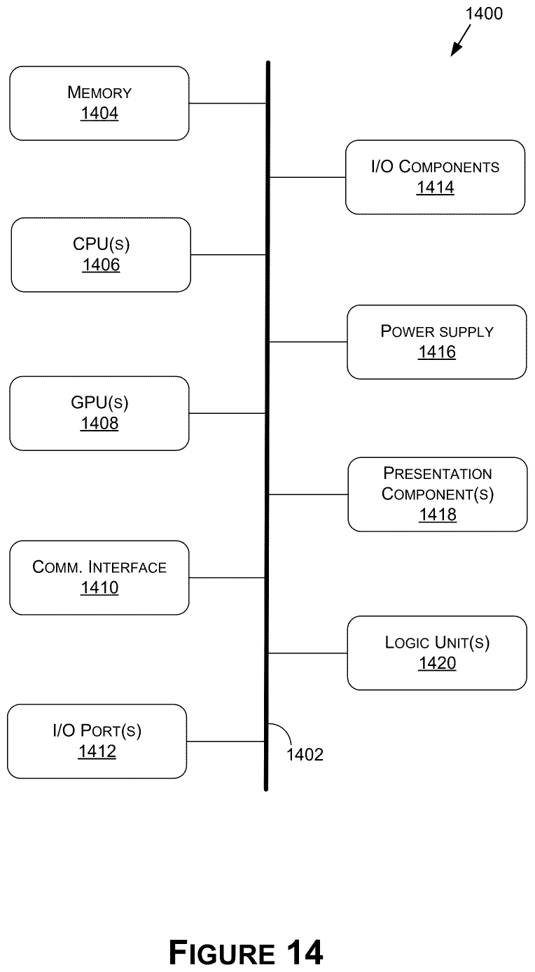

Systems and methods are disclosed related to dataset generation for safety evaluation of autonomous or semi-autonomous systems and applications. Although the present disclosure may be described with respect to an example autonomous or semi-autonomous vehicle, robot, and/or other machine type 1100 (alternatively referred to herein as “vehicle 1100,” “ego-vehicle 1100,” “machine 1100,” “ego-machine 1100,” “robot 1100,” and/or “ego-robot 1100,” an example of which is described with respect to FIGS. 11A-11E), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms (e.g., autonomous mobile robots (AMRs), humanoid robots, robotic arms and/or end-effectors, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle, robot, or machine types. In addition, although the present disclosure may be described with respect to test dataset generation for validation of autonomous or semi-autonomous machine safety objectives, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, simulation, and/or any other technology spaces where dataset generation may be used. In some embodiments, the systems, methods, and/or processes described herein may be executed using similar components, features, and/or functionality to those of example machine 1100 of FIGS. 11A-11E, example computing ecosystem 1200 of FIG. 12, example generative language model system 1300 of FIG. 13, and/or example computing device 1400 of FIG. 14.

For instance, in accordance with one or more embodiments of the present disclosure, a system(s) may generate test datasets that may be used for evaluating whether autonomous or semi-autonomous machines—including subsystems and/or components of the machines—meet defined safety goals. That is, the system(s) may be configured to translate the safety goals into one or more safety test datasets, which may then be used to validate whether the performance of a machine satisfies the safety goals in various test scenarios. In various examples, the system(s) may determine how much data is needed to support statistical validation, identify the types of driving scenarios associated with those goals, determine how the data should be distributed across real-world operating conditions, and apply labeling specifications to produce ground truth annotations. The resulting test dataset may be geofenced and access-controlled to preserve its independence from training data, and may be traceably linked to the safety goals it is intended to evaluate.

In some examples, the system(s) may obtain the safety goals (e.g., one or more safety goals) for a machine (e.g., an autonomous or semi-autonomous machine or vehicle). The safety goals may include or otherwise indicate behaviors or outcomes that the machine is expected to maintain with a certain degree of reliability. For example, a safety goal may require that a machine avoid collisions or remain within its lane boundaries under defined conditions. In some instances, one or more (e.g., each) of the safety goals may include a failure threshold that defines the maximum acceptable rate of failure for that behavior—such as no more than one collision per 10,000 hours of operation.

As described herein, in some instances, the system(s) may perform structured safety analysis with respect to one or more (e.g., each) of the safety goals. For instance, the system(s) may perform a fault-tree analysis with respect to the safety goal(s) to identify and organize the contributing causes of potential failures. Additionally, or alternatively, the system(s) may perform any other kind or type of hazard or failure mode analysis to develop a structured breakdown of potential failure modes and their contributing causes, each linked to a quantitative failure threshold. As an example, a fault-tree analysis may be used to determine that a collision could result from failures in perception, planning, or braking, each of which may carry a portion of the failure percentage allocated to that safety goal.

In some examples, the system(s) may determine threshold quantities of data (e.g., test data) for the safety goal(s). For instance, based at least on the results of the safety analysis—including the failure threshold(s) and/or the probability of contributing failures—the system(s) may determine threshold quantities of test data (e.g., sensor recordings, simulated scenarios, etc.) to include in the safety test dataset. These quantities may be calculated to ensure that, if no failures are observed, a high level of statistical confidence may be established that the system meets the safety goal. As a simple statistical rule, the lower the acceptable failure rate, the more data may be needed to validate it, and vice-versa. For instance, if the failure threshold is one in 10,000 hours, the system(s) may determine that at least 10,000 hours of relevant driving data should be collected and evaluated with zero failures to support the claim. As an example, if a safety goal specifies that the system should not collide with another vehicle more than once every 10,000 hours of driving, the system(s) may determine that at least 10,000 hours of relevant driving data involving other vehicles—such as highway driving, lane changes, or merging—should be included in the safety test dataset, and the machine running the test (e.g., the latest version of software associated with an autonomous or semi-autonomous vehicle) should be able to process this test data without a collision occurring.

In some instances, the system(s) may additionally account for statistical confidence bounds in the determination of required test data quantities. For example, to demonstrate with 95% confidence that a failure rate does not exceed one per 10,000 hours, the system(s) may determine that at least 30,000 hours of failure-free test data are needed. That is, the required number of hours may scale based on the desired confidence level in the resulting validation claim. Conversely, if a failure is observed within the collected dataset, the confidence in meeting the target failure rate may be reduced accordingly. As an example, if a single failure is observed in a 30,000-hour dataset, the confidence that the mean time between failures exceeds 10,000 hours may drop to approximately 60%. Accordingly, the system(s) may calculate test data quantities not only based on failure thresholds, but also based on statistical confidence requirements, thereby ensuring that the evaluation results are meaningful and supportable within the specified bounds.

In some instances, the system(s) may determine labeling specifications for the safety test data. For example, based at least on the results of the safety analysis and the specific failure modes under consideration, the system(s) may determine the labeling specifications required to evaluate system performance. In some examples, the labeling specifications may indicate the types of annotations needed—such as bounding boxes for obstacles, lane geometry for localization, or scenario tags to identify key events like unprotected left turns or merging maneuvers. The labeling requirements may, in some instances, vary based on the associated safety goal and the types of system behavior being assessed. For example, if the safety goal is to avoid collisions with pedestrians, the labeling specifications may include high-resolution bounding boxes for pedestrian instances, temporal continuity across frames to capture movement, and metadata describing crosswalk usage or pedestrian intent. If the goal involves safe navigation through intersections, the labels may include lane graphs, signal phase timing, and the presence of occluded or partially visible objects.

In various examples, the system(s) may also determine what types of driving scenarios are needed to evaluate one or more (e.g., each) of the safety goals. The scenarios may include common operational conditions as well as rare, safety-critical situations—such as a pedestrian stepping into the road at night or a vehicle cutting into the lane unexpectedly. The system(s) may use the failure modes, labeling needs, and/or statistical requirements to identify which scenarios should be represented and in what proportions. For instance, a dataset for evaluating a lane-keeping goal may require highway curves, construction zones, and poor lighting scenarios in specific ratios.

As described herein, in some examples, the system(s) may associate one or more (e.g., each) of the safety goals with one or more particular datasets. For example, the system(s) may store, within a requirements management tool (e.g., Jama), mappings between safety goals and the test data collected to support their validation—including quantities, scenario types, and/or labeling criteria. This may allow traceability throughout the safety validation process, helping to demonstrate that each goal is supported by a sufficient and appropriately composed dataset. The requirements management system may also help coordinate updates if safety goals change over time or if new failure modes are identified.

In some instances, the system(s) may also determine target data distributions across anticipated, real-world conditions the machine may operate in. For example, the system(s) may determine that certain percentages of the test data should represent day versus night, dry versus wet weather, or highway versus urban roads. In some instances, to determine the target distributions, the system(s) may access one or more operational usage models. The operational usage model(s) may indicate expected environmental and contextual conditions for deployed machines. For example, the model may indicate that 40% of operational hours are expected to occur in the U.S., 30% in Europe, and the rest in Asia, or that most deployments will occur in urban environments during daytime hours. These operating conditions may be collectively referred to as the Operational Design Domain (ODD), and the target distribution may help align the test dataset with the expected ODD. In some examples, the system(s) may apply the target distribution to the previously determined data quantity for a given safety goal. For instance, if 10,000 hours of highway driving data are needed to validate a collision avoidance goal, the system(s) may allocate that quantity across the target distribution—such as requiring that 40% of those hours occur in the U.S., 30% in Europe, and so forth, as well as that a defined portion include night or adverse weather conditions, and so forth. This combined use of quantity and distribution may ensure that the safety test dataset is both statistically sufficient and representative of real-world deployment.

In some instances, the system(s) may simplify the representation of anticipated operating conditions by grouping certain ODD categories into equivalence classes. For example, countries or regions that exhibit similar road infrastructure, traffic patterns, signage, and driving behavior may be grouped together and treated as a single class for the purposes of test data planning. This grouping may reduce the complexity of the target distribution without significantly impacting its representativeness. In various examples, the system(s) may use or define a similarity metric to support the equivalence claim—such as shared driving rules, vehicle speed distributions, or road usage patterns—and may document or justify the grouping based on that metric. This approach may help streamline data collection and labeling efforts while preserving alignment with the machine's expected real-world deployment conditions.

In some examples, the system(s) may obtain test data for the safety test dataset. For instance, the system(s) may obtain the test data to be included in the safety test dataset based on the target distributions, the identified scenarios, and/or the threshold quantity. As an example, to obtain the test data the system(s) may retrieve sensor recordings from prior field tests, select synthetic data generated by simulation tools, or deploy machines specifically for test data collection. In some examples, the test data may correspond to LIDAR, camera, or radar sensor recordings, and may include conditions such as night driving, poor weather, or unstructured roads. The system(s) may use tagging or filtering methods to ensure that the data collected matches the planned composition of the dataset. In some examples, the system(s) may iteratively obtain portions of the test data and evaluate whether additional and/or new test data is needed, or if the acquired total of the test data satisfies one or more of the data quantity, scenario type, and/or target distribution requirements/thresholds. That is, as an example, if the dataset needs to include 10,000 hours of highway driving and 20% of those hours (2,000) need to correspond to night driving scenarios, the system(s) may iteratively obtain additional test data corresponding to highway night driving until those thresholds are satisfied.

In some examples, the system(s) may perform geofencing to ensure the test data minimally overlaps with other data, such as training data used to train one or more systems or components of the machine that is being tested. This separation may help ensure the independence of the test dataset and avoid overfitting to known environments. For instance, if a machine is deployed to collect test data, the system(s) may ensure the machine is deployed on routes that differ from those used for training purposes. In some examples, information (e.g., metadata) about route identifiers, geographic regions, or collection sessions may be used to enforce geofencing constraints.

In various instances, the system(s) may use the labeling specifications to generate ground truth data corresponding to the test data. For instance, the system(s) may apply automated labeling tools or human annotation pipelines to generate object annotations, lane information, traffic signal states, or other features required for evaluation of how the machine performs during the test. In some cases, multiple label types may be applied to a single test data recording to support validation of multiple safety goals. For example, a sensor data recording of a busy urban intersection may include bounding boxes for pedestrians and vehicles to support object detection goals, lane topology labels for lane-keeping validation, and metadata indicating traffic light phases and crosswalk usage to evaluate behavior in traffic-controlled environments.

The system(s) may store the obtained test data (e.g., recordings, simulations, etc.) and their corresponding labeled ground truth data as one or more safety test datasets. In some examples, one or more (e.g., each) of the safety test dataset(s) may be organized with metadata that links it to the safety goal it is intended to support. The structure may support traceability, auditability, and filtering based on scenario, condition, or data source. In various instances, the safety test dataset(s) may be stored in a secure environment, isolated from training data, and may be subject to access and modification controls to maintain its integrity. For instance, the system(s) may restrict access to the safety test dataset(s) within the organization, and safety-related datasets may be access-controlled upon ingestion, allowing only designated teams—such as those responsible for safety validation—to use or view the data. In some examples, the system(s) may implement a process to manage how and when information about the safety test dataset(s) is shared with other parts of the organization, helping to minimize the risk of unintentional reuse in training workflows and preserving the objectivity of the evaluation.

In various examples, the system(s) may use the safety test dataset(s) to evaluate performance of the machine and/or subsystems or components of the machine. For instance, sensor recordings of the safety test dataset(s) may be replayed into one or more subsystems of the machine, such as perception, planning, control modules, etc. as if the data were coming from live sensors. The outputs of these systems may be compared against the labeled ground truth to determine whether the systems performed correctly under the tested conditions. This evaluation may be used to determine whether the machine's behavior statistically satisfies the defined safety goals across the range of driving scenarios and ODD conditions included in the dataset.

In some embodiments, one or more aspects of the systems and methods described herein may be performed within a simulation environment (e.g., NVIDIA's DriveSIM, ISAAC Sim, ISAAC Gym, ISAAC Lab, etc.) using simulated data (e.g., simulated environmental data and simulated sensor data of simulated sensors of a virtual or simulated vehicle, robot, or machine within the simulated environment). For example, a simulation environment may be used to replicate rare or hazardous scenarios—such as low-visibility pedestrian crossings or high-speed merges—that may be underrepresented or impractical to collect in real-world datasets. In some instances, the simulation may be used to generate synthetic test data—e.g., camera, radar, and lidar recordings from procedurally generated urban environments under varied lighting and weather conditions, with synthetic annotations for object detection, lane following, and hazard prediction. The synthetic test data (in addition to or alternatively from real-world data) may then be used or processed to supplement real-world test datasets, fill in underrepresented operational design domain (ODD) segments, or serve as fully synthetic safety test datasets to validate compliance with defined failure thresholds.

In any example, such as where a simulation environment is used for test data generation, testing, validation, training, etc., the simulation environment and/or associated training data may be rendered or otherwise generated using one or more light transport simulation algorithms—such as one or more ray-tracing and/or path-tracing algorithms. Where light transport simulation is used, the simulation system may employ one or more dedicated ray-tracing hardware accelerators and/or processors (e.g., NVIDIA's RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA's OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA's PhysX software developer kit (SDK)), in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, and/or testing AI systems—such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a data center, an airport, a geographic area, a marine area, and/or any other real environment where autonomous or semi-autonomous vehicles or machines may operate.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), vision-language-action (VLA) models, and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

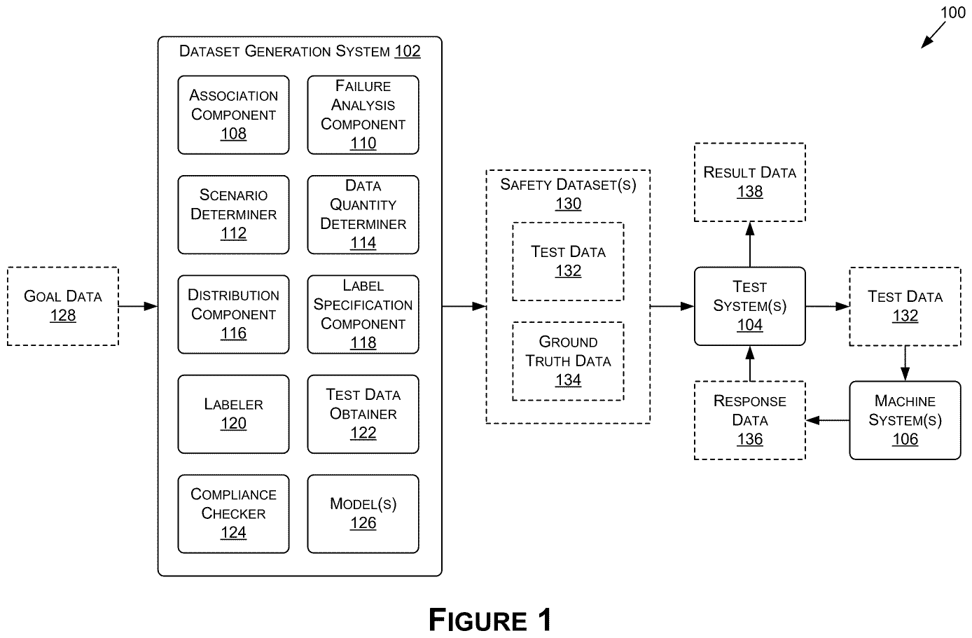

With reference to FIG. 1, FIG. 1 is a system-level data flow diagram illustrating an example of a process 100 for generating and using a safety test dataset to evaluate performance of a machine with respect to one or more safety goals, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs), deep learning accelerator cluster (XNNs), neural network accelerators (NNAs), and/or neural processing units (NPUs), programmable vision accelerators (PVAs), optical flow accelerators (OFAs), etc.), application specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1100 of FIGS. 11A-11E, example computing ecosystem 1200 of FIG. 12, example generative language model system 1300 of FIG. 13, and/or example computing device 1400 of FIG. 14.

As shown in the example of FIG. 1, the process 100 may be implemented using, amongst additional or alternative systems or components, a dataset generation system 102, one or more test systems 104, and one or more machine systems 106. Additionally, the dataset generation system 102 may include, amongst additional or alternative components, an association component 108, a failure analysis component 110, a scenario determiner 112, a data quantity determiner 114, a distribution component 116, a label specification component 118, a labeler 120, a test data obtainer 122, a compliance checker 124, and one or more models 126, which may be used by the dataset generation system 102 to implement at least a portion of the process 100.

As a brief overview of the process 100, the dataset generation system 102 may receive and process goal data 128 representing one or more safety goals for a machine. The dataset generation system 102 may process the goal data 128 using one or more of the association component 108, the failure analysis component 110, the scenario determiner 112, the data quantity determiner 114, the distribution component 116, the label specification component 118, the labeler 120, the test data obtainer 122, the compliance checker 124, and/or the model(s) 126 to generate one or more safety datasets 130, which may include test data 132 and corresponding ground truth data 134. The test system(s) 104 may receive the safety dataset(s) 130 and apply the test data 132 as input to the machine system(s) 106. The test system(s) 104 may then evaluate response data 136—representing one or more responses of the machine system(s) 106 based on the input test data 132—using the ground truth data 134, and output result data 138 representing results of the test (e.g., indicating how the machine system(s) 106 performed with respect to the safety goals).

In some examples, the goal data 128 may represent one or more safety goals for a machine. The safety goals may include or otherwise indicate behaviors or outcomes that the machine is expected to maintain with a certain degree of reliability. For example, a safety goal may require that a machine avoid collisions or remain within its lane boundaries under defined conditions. In some instances, one or more (e.g., each) of the safety goals may include a failure threshold that defines the maximum acceptable rate of failure for that behavior—such as no more than one collision per 10,000 hours of operation. In some embodiments, the goal data 128 may also include metadata describing severity, controllability, and/or exposure metrics for associated failure conditions. These factors may be used to prioritize goals or to determine whether certain failure modes warrant specialized test data collection efforts. Additionally, the goal data 128 may include operational context information—such as scenario types (e.g., intersections, merges, or crosswalks), geographic zones (e.g., U.S. versus EU), or ODD classifications (e.g., lighting, weather, traffic density)—that inform how the safety goal should be tested and validated.

The association component 108 of the dataset generation system 102 may be configured to associate one or more (e.g., each) safety goals from the goal data 128 with one or more corresponding test datasets that are intended to support evaluation of that safety goal(s). In some examples, the safety goal(s) may be coupled to a particular dataset(s) using a requirements management system (e.g., Jama). This association may enable traceability between safety goals and the test data used to validate them, ensuring that the composition and purpose of the dataset remain aligned with the defined safety requirements throughout the development and evaluation process.

The failure analysis component 110 may perform structured safety analysis with respect to one or more (e.g., each) of the safety goals represented in the goal data 128. For example, the failure analysis component 110 may perform a fault-tree analysis to identify and organize the contributing causes of potential failure events associated with a given safety goal. This analysis may deconstruct a high-level hazard—such as a collision, loss of control, or unsafe lane departure—into one or more intermediate or lower-level events, which may include sensing errors, planning faults, control delays, or unexpected interactions with the environment. In some instances, probability values may be assigned to these contributing events, enabling an estimation of how likely the top-level failure might occur under real-world operating conditions.

Alternatively, or in addition or combination with fault-tree analysis, the failure analysis component 110 may incorporate other approaches to hazard modeling and system safety assessment. For instance, the component 110 may apply failure mode and effects analysis (FMEA), event tree analysis, or probabilistic risk modeling to explore how failures may emerge or propagate through different subsystems. The failure analysis may consider various sources of uncertainty—including sensor degradation, localization drift, software logic faults, or external disturbances—and may provide structured outputs that reflect how these factors relate to the defined safety goals.

As an illustrative example, a fault-tree analysis may identify that a potential collision with another vehicle could stem from one or more contributing issues in perception, planning, or braking. These contributing causes may be associated with quantitative failure probabilities or scenario-specific exposure rates. For instance, a portion of the collision risk may arise from missed object detections in urban environments, while another portion may be related to poor path selection in congested intersections. The resulting analysis may be used by one or more downstream components—such as the scenario determiner 112, the data quantity determiner 114, or the label specification component 118—to inform what kinds of test data should be collected, how much of it is needed, and how it should be labeled or structured to support safety validation.

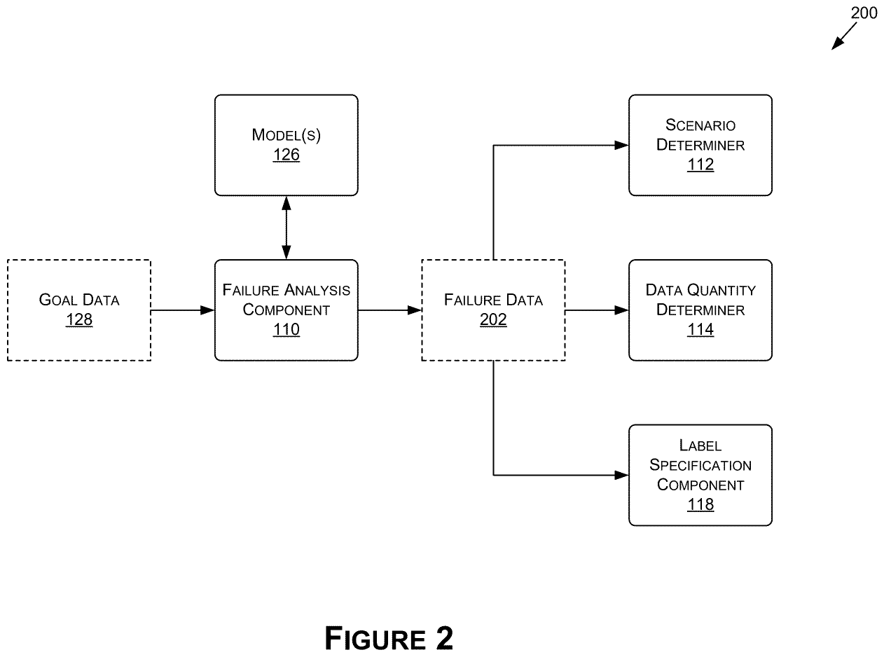

Referring to FIG. 2, FIG. 2 illustrates an example of a process 200 for performing a failure analysis, in accordance with some embodiments of the present disclosure. As shown, the failure analysis component 110 may receive the goal data 128 that specifies one or more safety goals to be validated. Based on this input, the failure analysis component 110 may generate failure data 202 that may reflect a structured breakdown of potential failure modes and their contributing causes. In some examples, the failure analysis component 110 may make calls to or otherwise interact with the model(s) 126—such as fault-tree models, hazard models, behavioral models, or statistical failure prediction models—to support or augment the analysis. The failure data 202 may include, for example, intermediate failure events, system-level hazard pathways, or quantitative risk allocations linked to specific subsystems or operational scenarios. As shown, the generated failure data 202 may then be shared with one or more components of the dataset generation system 102 to guide subsequent processing. For instance, the failure data 202 may be provided to the scenario determiner 112, the data quantity determiner 114, and/or the label specification component 118.

Referring back to the example of FIG. 1, the process 100 may include the scenario determiner 112 determining what types of driving scenarios are needed to evaluate one or more (e.g., each) of the safety goals. In some examples, the scenarios may be determined based on the results of fault analysis that identifies potential conditions or events under which failures may be more likely to occur or more difficult to detect. In various examples, the scenarios may reflect both typical operational environments and rarer, safety-critical situations that are relevant to the system's intended use. These may include, for instance, a pedestrian stepping into the roadway at night, a vehicle merging unexpectedly at high speeds, an unprotected left turn in an urban intersection, or travel through a construction zone with temporary lane markings. In some cases, the scenario determiner 112 may identify which types of scenarios are necessary to validate whether the machine system(s) 106 is likely to behave correctly across the expected range of operating conditions. This may include considering how frequently different types of scenarios occur, how much risk they present, and what kinds of behaviors are expected from the system under test. For example, scenarios may be selected to assess compliance with safety goals related to object detection, lane keeping, collision avoidance, or safe interaction with traffic infrastructure.

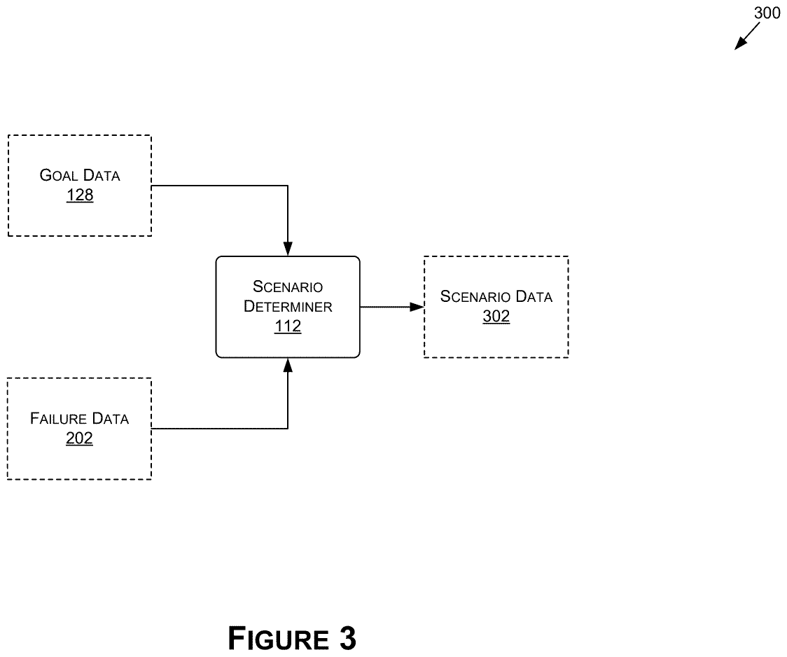

For example, FIG. 3 illustrates an example of a process 300 for determining types of driving scenarios for evaluating safety goals, in accordance with some embodiments of the present disclosure. As shown, the scenario determiner 112 may receive the goal data 128 and/or the failure data 202. The goal data 128 may represent the one or more (e.g., each) safety goals for a machine, and the failure data 202 may correspond to the safety goals and describe potential failure modes, system-level risks, or conditions under which those goals may be more difficult to satisfy. In some instances, based on this information, the scenario determiner 112 may generate scenario data 302 representing one or more types of driving scenarios that should be represented or included in the safety test dataset to enable meaningful validation. The scenarios may reflect, in some instances, operational contexts associated with increased likelihood of failure or heightened safety impact, such as interactions with pedestrians in low-visibility conditions, complex merges during heavy traffic, or navigation through partially occluded intersections. In some examples, the selected scenarios may include both commonly encountered and less frequent but safety-critical conditions that align with how the system is expected to operate in the real world. The scenario data 302 may, in some instances, describe the selected types of scenarios, which may include information about environment types, actor behaviors, event triggers, and/or system stressors. In some cases, the scenario data 302 may also include recommended distributions or priorities to ensure alignment with safety validation goals and anticipated deployment conditions.

Now referring back to the example of FIG. 1, the process 100 may also include the dataset generation system 102 using the data quantity determiner 114 to determine one or more threshold quantities of test data for the safety goal(s). For instance, the data quantity determiner 114 may analyze the failure threshold(s) associated with the safety goal(s), as well as the probability or likelihood of contributing failure modes identified through the safety analysis. Based on this information, the data quantity determiner 114 may calculate a minimum amount of test data—such as sensor recordings, simulated scenarios, or synthetic datasets, etc.—needed to establish statistical confidence that the machine system(s) 106 satisfies the corresponding safety goal.

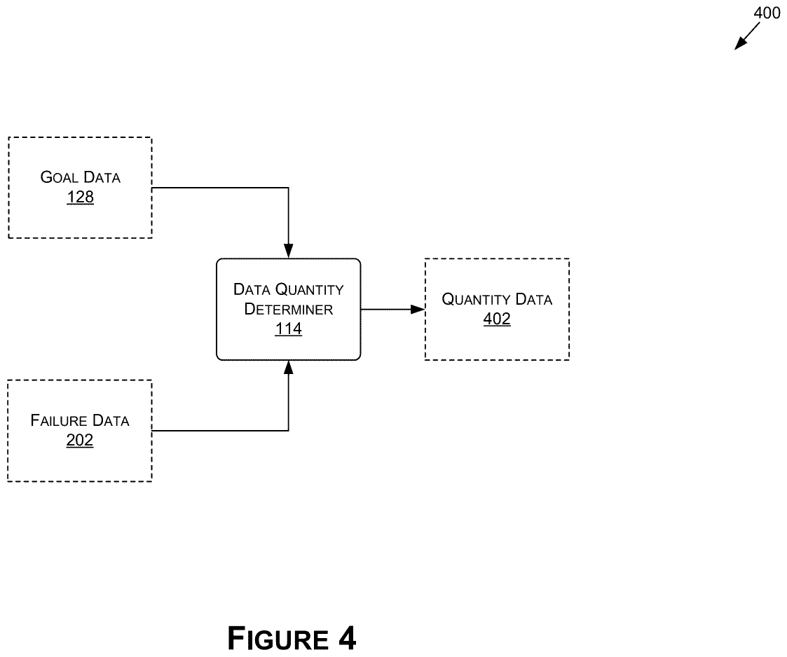

For instance, FIG. 4 illustrates an example of a process 400 for determining a quantity of test data for evaluating safety goals, in accordance with some embodiments of the present disclosure. As shown, the data quantity determiner 114 may receive input from one or more sources, such as the goal data 128 and/or the failure data 202, and may generate quantity data 402 representing the threshold quantity(ies) of the test data to be included in a safety test dataset and/or for proving one or more safety goals. In some examples, the data quantity determiner 114 may determine the threshold quantity(ies) of the test data using statistical confidence techniques, some of which may consider the rarity of acceptable failure rates. That is, the lower the permitted failure rate, the more data may be required to validate compliance in the absence of observed failures. For example, if a safety goal defines a failure threshold of no more than one incident per 10,000 hours of operation, the data quantity determiner 114 may determine that at least 10,000 hours of representative test data should be processed with zero failures observed to support a claim of compliance at the desired confidence level. As described herein, in some instances, this test data may be distributed across relevant driving contexts—such as urban intersections, multi-lane highways, or mixed-traffic environments—depending on how the safety goal(s) is defined.

For example, if a safety goal specifies a maximum failure threshold of one incident per 10,000 hours of operation, the data quantity determiner 114 may determine that the machine system(s) 106 must be tested using at least 10,000 hours of relevant driving data—during which no failures are observed—in order to claim compliance with a desired level of statistical confidence. In some examples, the test data may be distributed across multiple scenario types, operational contexts, and environmental conditions depending on the definition and scope of the safety goal. These scenarios may include urban intersections, highway merges, dense traffic, adverse weather, or nighttime driving, among others.

As an illustrative example, if a safety goal requires that the machine system(s) 106 avoid collisions with other vehicles at a rate better than one incident per 10,000 hours, the dataset generation system 102 may determine that the safety test dataset must include at least 10,000 hours of test data involving vehicle-to-vehicle interactions. These may include scenarios such as lane changes, car-following, merging, or stop-and-go traffic conditions. In some instances, the data quantity determiner 114 may also apply conditional weighting—emphasizing scenarios where collision risk is elevated or where failure modes (e.g., missed detections, misclassifications, or poor planning responses) are known to be more likely.

In various examples, the data quantity output generated by the data quantity determiner 114 may be and passed to one or more downstream components of the dataset generation system 102—such as the distribution component 116 and/or the test data obtainer 122—to guide dataset construction and ensure that test data aligns with the quantitative requirements necessary for robust and reproducible safety validation.

Referring back to the example of FIG. 1, the label specification component 118 of the dataset generation system 102 may determine labeling specifications for the safety test data. For example, based at least on the results of the safety analysis and the specific failure modes under consideration, the label specification component 118 may determine the labeling specifications required to evaluate system performance. In some examples, the labeling specifications may indicate the types of annotations needed for ground truth data—such as bounding boxes for obstacles, lane geometry for localization, or scenario tags to identify key events like unprotected left turns or merging maneuvers. The labeling requirements may, in some instances, vary based on the associated safety goal and the types of system behavior being assessed. For example, if the safety goal is to avoid collisions with pedestrians, the labeling specifications may include high-resolution bounding boxes for pedestrian instances, temporal continuity across frames to capture movement, and metadata describing crosswalk usage or pedestrian intent. As another example, if the goal involves safe navigation through intersections, the labels may include lane graphs, signal phase timing, and the presence of occluded or partially visible objects.

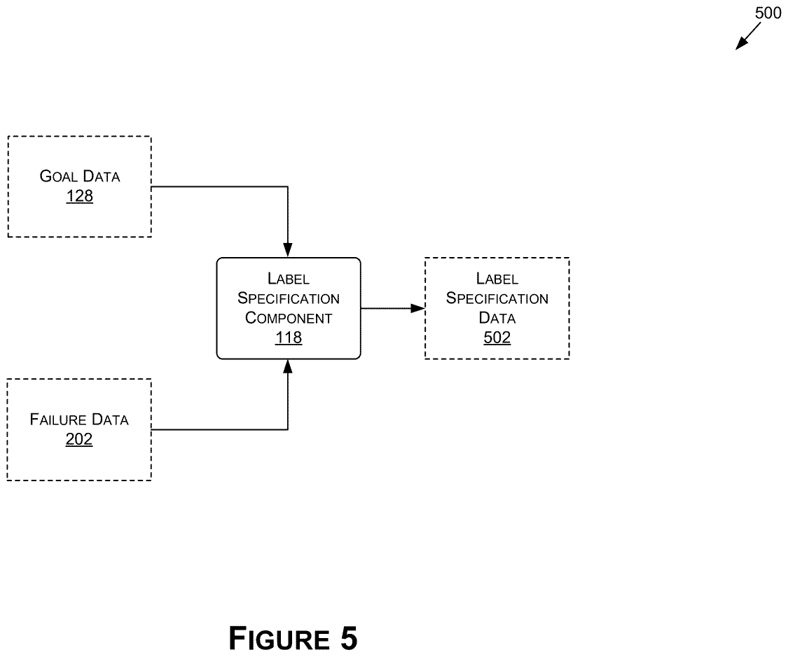

For instance, FIG. 5 illustrates an example of a process 500 for generating labeling specifications for test data, in accordance with some embodiments of the present disclosure. As shown, the label specification component 118 may receive goal data 128 and/or failure data 202 as input, and based on this information, generate label specification data 502 representing one or more label specifications for the test data, such as what types of annotations or metadata should be applied to the test data in order to evaluate whether one or more (e.g., each) of the safety goals is satisfied. In some examples, the label specification component 118 may analyze the failure modes associated with a given safety goal and identify observable features in the test data that would indicate either the occurrence or avoidance of those failures.

The label specification data 502 may, in some examples, define the required annotation schema for each relevant scenario or safety objective. These labeling specifications may include, for example, bounding boxes around dynamic or static obstacles, object classifications, lane topology, semantic segmentation masks, or time-aligned event tags for key driving behaviors such as merging, stopping, or turning. In certain embodiments, the label specifications may also include temporal consistency requirements—such as object tracking across consecutive frames—or structured metadata such as pedestrian intent, vehicle turn signals, or road signage status. Additionally, in some examples, the label specification data 502 may vary depending on the nature of the safety goal. For example, for a goal related to pedestrian collision avoidance, the label specification component 118 may generate specifications requiring high-resolution bounding boxes for pedestrians, annotations for pedestrian movement vectors, and contextual cues such as whether the pedestrian is inside a crosswalk. For a goal involving safe behavior at intersections, the specifications may include lane graphs, traffic signal phase timing, and annotations for occlusions or partially visible vehicles.

Referring back to the example of FIG. 1, in some examples, the distribution component 116 may be configured to determine target data distributions across anticipated, real-world conditions the machine may operate in. For example, the distribution component 116 may determine that certain percentages of the test data should represent day versus night, dry versus wet weather, or highway versus urban roads. In some instances, to determine the target distributions, the distribution component 116 may access the model(s) 126, such as one or more operational usage models. The operational usage model(s) may indicate expected environmental and/or contextual conditions for deployed machines. For example, the model may indicate that 40% of operational hours are expected to occur in the U.S., 30% in Europe, and the rest in Asia, or that most deployments will occur in urban environments during daytime hours. These operating conditions may be collectively referred to as the Operational Design Domain (ODD), and the target distribution may help align the test dataset with the expected ODD. In some examples, the distribution component 116 may apply the target distribution to the previously determined data quantity for a given safety goal. For instance, if 10,000 hours of highway driving data are needed to validate a collision avoidance goal, the system(s) may allocate that quantity across the target distribution—such as requiring that 40% of those hours occur in the U.S., 30% in Europe, etc., as well as that a defined portion include night or adverse weather conditions, and so forth. This combined use of quantity and distribution may ensure that the safety test dataset(s) 130 is both statistically sufficient and representative of real-world deployment.

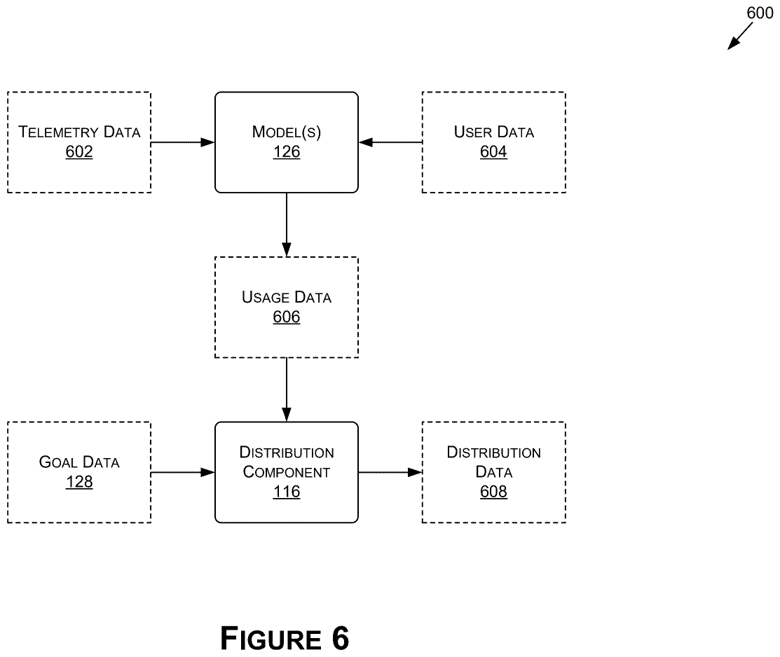

FIG. 6 illustrates an example of a process 600 for determining a target distribution for test data across anticipated driving conditions, in accordance with some embodiments of the present disclosure. As shown, the distribution component 116 may receive goal data 128 and usage data 606 derived from the model(s) 126 (e.g., one or more operational models). In some examples, the model(s) 126 may be trained or informed by telemetry data 602 and/or user data 604 representing how deployed machines are expected to operate across different environments, regions, or usage contexts. In some examples, the telemetry data 602 may include information collected from real-world field operations—such as route types, speed profiles, environmental conditions, or time-of-day activity—while the user data 604 may reflect information associated with end users of the machines, customer deployment configurations, regional usage patterns, or anticipated demand across various ODDs. Based on these inputs, the model(s) 126 may generate usage data 606 representing expected exposure distributions, such as the percentage of operational time a machine may spend on highways, in dense urban areas, during nighttime, or in specific geographic zones or countries.

The distribution component 116 may use the usage data 606 and the safety goal(s) defined in the goal data 128 to determine a target distribution across environmental, geographic, and contextual dimensions. For instance, if a safety goal requires validation of highway lane-keeping behavior, the distribution data 608 may specify that the associated test data be allocated across dry, wet, and icy road surfaces, or across lighting conditions such as daylight, dusk, and night, in proportion to the actual amount of time the machines may operate in those conditions.

The distribution data 608 may define one or more proportions or allocation criteria for collecting or generating test data that matches the expected real-world deployment of the machine system(s). In some examples, the distribution data 608 may be used by downstream components—such as the test data obtainer 122 or the scenario determiner 112—to guide dataset construction in a way that is aligned with how and where the machine is expected to operate, supporting more representative and statistically meaningful safety validation.

Referring back to FIG. 1, in some instances, the distribution component 116 may simplify the representation of anticipated operating conditions by grouping certain ODD categories into equivalence classes. For example, countries or regions that exhibit similar road infrastructure, traffic patterns, signage, weather, and/or driving behavior may be grouped together and treated as a single class for the purposes of test data planning. This grouping may reduce the complexity of the target distribution without significantly impacting its representativeness. In various examples, the distribution component 116 may use or define a similarity metric to support the equivalence claim—such as shared driving rules, vehicle speed distributions, or road usage patterns—and may document or justify the grouping based on that metric. This approach may help streamline data collection and labeling efforts while preserving alignment with the machine's expected real-world deployment conditions.

In some examples, the test data obtainer 122 of the dataset generation system 102 may be configured to obtain the test data 132 for the safety dataset(s) 130. For instance, the test data obtainer 122 may obtain the test data 132 to be included in the safety dataset(s) 130 based on the target distributions (e.g., distribution data 608), the identified scenarios (e.g., scenario data 302), and/or the threshold quantity of test data to be obtained (e.g., quantity data 402). As an example, to obtain the test data 132 the test data obtainer 122 may retrieve sensor recordings from prior machine driving sessions, select synthetic data generated by simulation tools, or deploy data collection machines specifically for test data 132 collection. In some examples, the test data 132 may correspond to sensor data recordings, such as LIDAR, camera, radar, ultrasonic, or any other type of sensor recordings, and may include conditions such as night driving, poor weather, or unstructured roads. The test data obtainer 122 may use tagging or filtering methods to ensure that the data collected corresponds to the planned composition of the dataset. These tagging or filtering operations may include evaluating metadata associated with sensor recordings—such as time of day, environmental conditions, scenario labels, or geographic identifiers—to identify data segments that satisfy one or more dataset composition or distribution requirements.

In some examples, the test data obtainer 122 may iteratively obtain portions of the test data 132, and then use the compliance checker 124 to evaluate whether additional and/or new test data 132 is needed, or if the acquired total of the test data 132 satisfies one or more of the data quantity, scenario type, and/or target distribution requirements/thresholds. That is, as an example, if the dataset needs to include 10,000 hours of highway driving and 20% of those hours (2,000) need to correspond to night driving scenarios, the test data obtainer 122 may iteratively obtain additional test data 132 corresponding to highway night driving until those thresholds are satisfied, as determined by the compliance checker 124.

In some examples, the test data obtainer 122 may perform geofencing to ensure the test data 132 minimally overlaps with other data, such as training data used to train the machine system(s) 106. This separation may help ensure the independence of the safety dataset(s) 130 and avoid overfitting to known environments. For instance, if a machine is deployed to collect test data, the test data obtainer 122 may ensure the machine is deployed on routes that differ from those used for training purposes. In some examples, information (e.g., metadata) about route identifiers, geographic regions, or collection sessions may be used to enforce geofencing constraints.

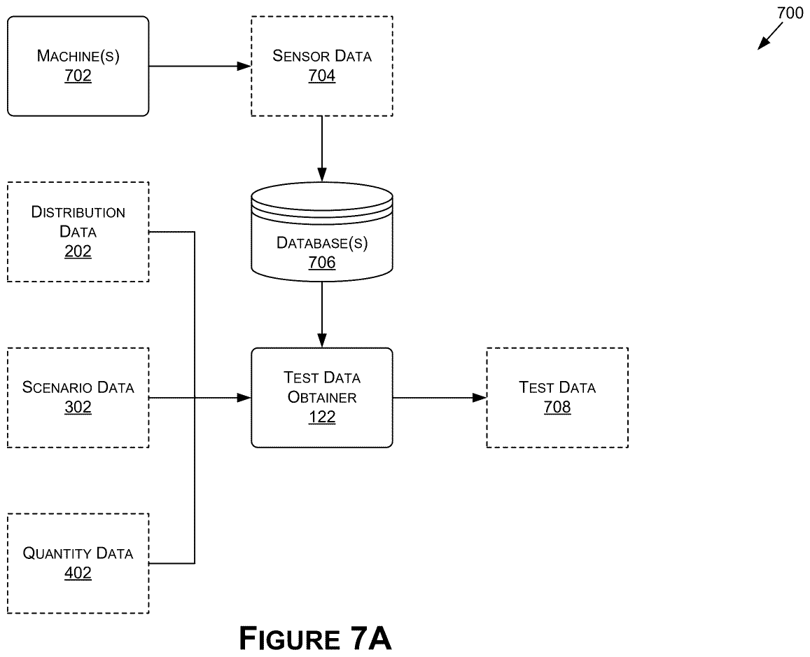

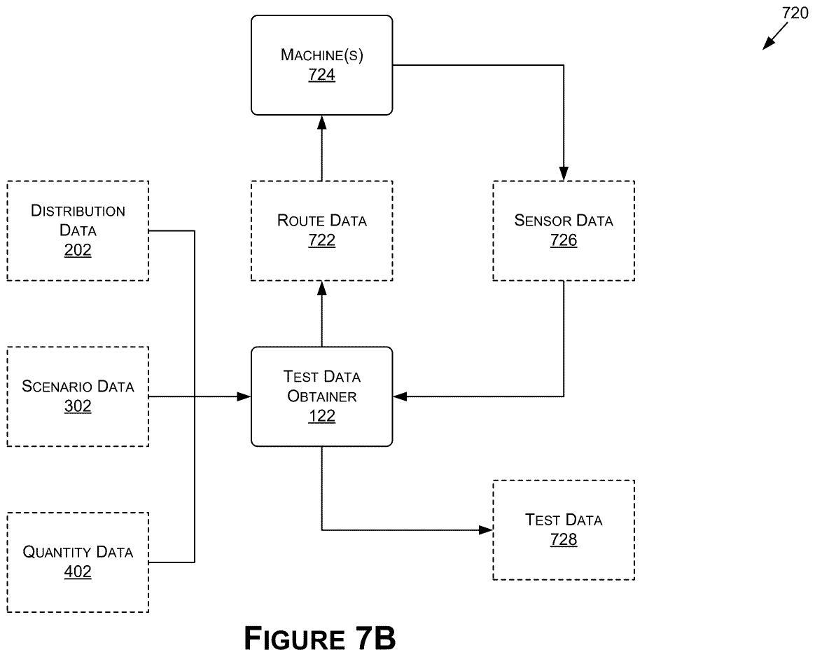

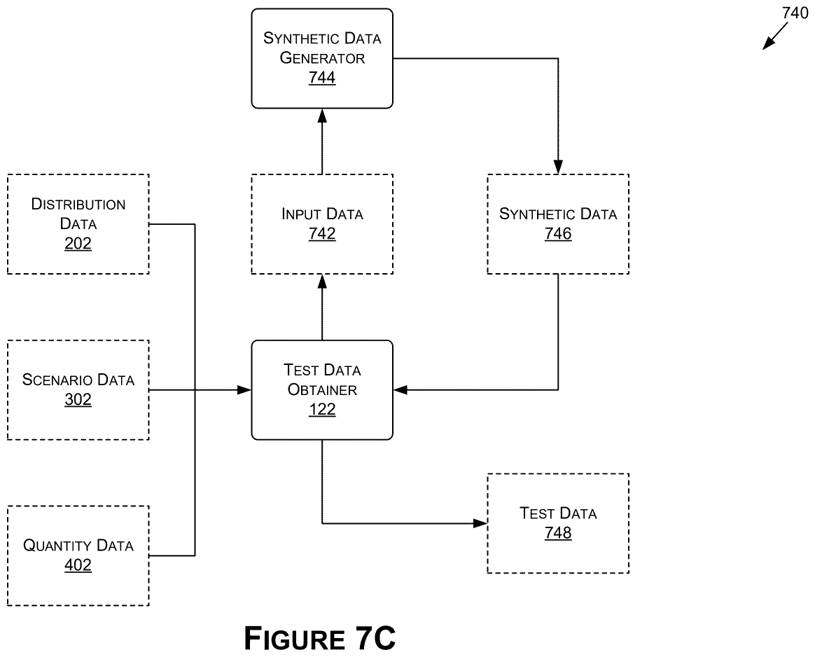

As described above and herein, the test data obtainer 122 may obtain the test data 132 for the safety dataset(s) 130 in a number of ways. For instance, FIG. 7A illustrates an example of a process 700 for obtaining test data for a safety test dataset from one or more databases storing sensor data, in accordance with some embodiments of the present disclosure. As shown, one or more machines 702—such as autonomous or semi-autonomous vehicles or robots—may generate sensor data 704 during operation. The sensor data 704 may include, for example, time-stamped camera, LIDAR, radar, ultrasonic, inertial measurement unit (IMU), or any other type of sensor recordings. Additionally, in some examples, the sensor data 704 may include metadata indicating conditions associated with the recordings, such as time of day, location, weather, traffic context, or any other kind of conditions. The sensor data 704 may be stored in one or more databases 706, which may be local or cloud-based data repositories capable of indexing, organizing, and/or retrieving historical machine and/or sensor recordings. The test data obtainer 122 may access the database(s) 706 and apply one or more filtering, querying, or sampling techniques to select portions of the stored sensor data 704 that satisfy test dataset requirements. For example, the test data obtainer 122 may reference the distribution data 202, the scenario data 302, and/or the quantity data 402 to determine what sensor data 704 to extract from the database(s) 706 as the test data 708. These inputs (e.g., the distribution data 202, the scenario data 302, and/or the quantity data 402) may indicate what types of environments, scenarios, or operating conditions must be represented in the final safety test dataset and how much data is needed for each condition. Based on these parameters, the test data obtainer 122 may retrieve and output selected test data 708 that aligns with the dataset composition/distribution plan.

As another example of how the test data obtainer 122 may obtain the test data, FIG. 7B illustrates an example of a process 720 for obtaining test data for a safety test dataset by deploying one or more machines to generate sensor data, in accordance with some embodiments of the present disclosure. As shown, the test data obtainer 122 may generate route data 722 representing deployment routes for one or more machines 724 (e.g., autonomous or semi-autonomous vehicles or robots) based on one or more inputs such as the distribution data 202, the scenario data 302, and/or the quantity data 402. These inputs may define the operational contexts, environmental conditions, or scenario types that must be represented in the safety dataset, along with how much data is needed for each type. In some instances, the test data obtainer 122 may use this information to generate the route data 722, which may, among other things, specify where and when the machine(s) 724 should be deployed to collect relevant sensor data 726. In some cases, the route data 722 may include geographic regions, time-of-day constraints, weather condition requirements, and/or scenario-specific criteria, such as intersection density, road type, or traffic complexity. In some examples, the route data 722 may be transmitted to the machine(s) 724 to guide their test or data collection operation. As the machine(s) 724 are deployed according to the specified route data 722, they may generate the sensor data 726- such as camera, radar, LIDAR, or other sensory recordings-along with relevant metadata reflecting the environmental and contextual conditions during operation. In some examples, the sensor data 726 may be transmitted or otherwise made available to the test data obtainer 122, and the test data obtainer 122 may select at least a portion of the sensor data 726 to use as the test data 728. For instance, the test data obtainer 122 may evaluate whether the collected sensor data 726 satisfies the requirements defined by the distribution data 202, scenario data 302, and/or quantity data 402, and based on this evaluation, the test data obtainer 122 may select the portion of the sensor data 726 as the test data 728 to be included in the safety test dataset.

Additionally, FIG. 7C illustrates yet another example of a process 740 for generating synthetic data to use as test data for a safety test dataset, in accordance with some embodiments of the present disclosure. As shown, the test data obtainer 122 may generate or select input data 742 based on one or more inputs such as the distribution data 202, the scenario data 302, and/or the quantity data 402. The input data 742 may describe scene-level parameters, behavioral conditions, or environmental features that should be present in the synthesized data—such as specific actor trajectories, lighting or weather conditions, or rare but safety-critical edge-case scenarios. The input data 742 may be provided to a synthetic data generator 744, which may be configured to produce simulation-based or procedurally generated synthetic data 746 that reflects the conditions described in the input data 742. In various examples, the synthetic data generator 744 may correspond to a simulation platform, physics engine, or content creation tool that can generate realistic sensor emulations—including LIDAR, camera, radar, or multimodal outputs—within digitally rendered environments. In some cases, the synthetic data 746 may also include ground truth annotations, metadata, or scene graphs useful for evaluating system behavior in controlled but diverse conditions.

Once generated, the synthetic data 746 may be transmitted or otherwise made available to the test data obtainer 122, which may select at least a portion of the synthetic data 746 as the test data 748 to be included in the safety test dataset. In some examples, the test data obtainer 122 may use the original dataset requirements—including the quantity, distribution, and scenario composition—to guide which portions of the synthetic data 746 are selected. In some examples, the synthetic data 746 may be used to augment real-world data, backfill underrepresented ODD conditions, or create fully synthetic test datasets for safety validation in rare or hazardous situations that are difficult or unsafe to collect through physical deployments.

Now referring back again to the example of FIG. 1, the process 100 may also include the labeler 120 of the dataset generation system 102 generating the ground truth data 134 corresponding to the test data 132 of the safety dataset(s) 130. In some examples, the labeler 120 may use the labeling specifications determined using the label specification component 118 to generate the ground truth data 134 corresponding to the test data 132. For instance, the labeler 120 may apply automated labeling tools to generate object annotations, lane information, traffic signal states, or other features required for evaluation of how the machine system(s) 106 performs during test execution. In some instances, multiple label types may be applied to a single test data 132 recording to support validation of multiple safety goals. For example, a sensor data recording of a busy urban intersection may include bounding boxes for pedestrians and vehicles to support object detection goals, lane topology labels for lane-keeping validation, and/or metadata indicating traffic light phases and/or crosswalk usage to evaluate behavior in traffic-controlled environments.

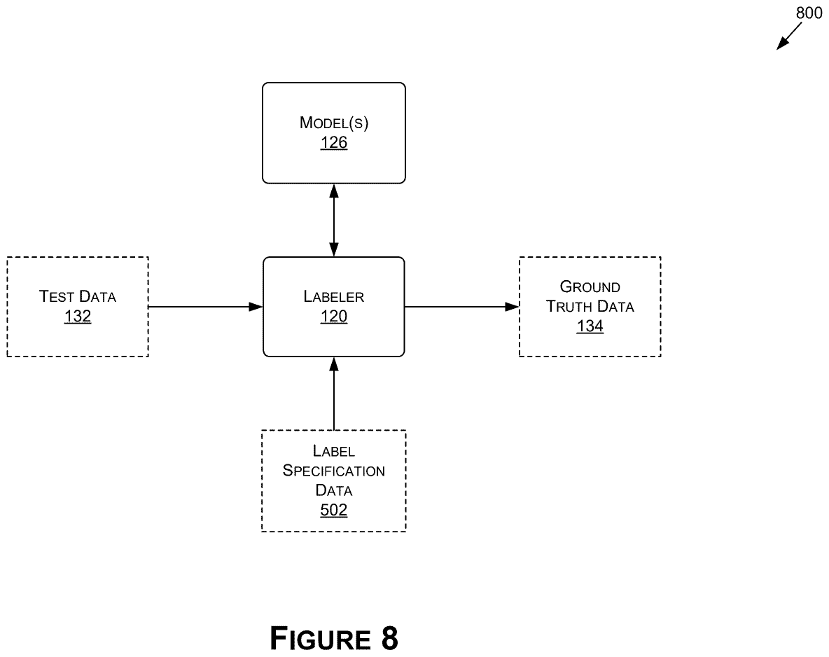

For instance, FIG. 8 illustrates an example of a process 800 for generating the ground truth data 134 corresponding to the test data 132, in accordance with some embodiments of the present disclosure. As shown, the labeler 120 may receive the test data 132 and the label specification data 502 as inputs. The test data 132 may include sensor recordings, synthetic data recordings (e.g., simulation recordings, simulated sensor data recordings, etc.), or any other test data previously selected or generated to be included in the safety test dataset. In some instances, the label specification data 502 may define the types of annotations or structured metadata to be applied, including, for example, bounding boxes, segmentation masks, object classifications, scene tags, or temporal tracking identifiers. Based on these inputs, the labeler 120 may generate corresponding ground truth data 134 that satisfies the predefined labeling requirements. In some examples, the labeler 120 may use one or more model(s) 126—such as machine learning-based labeling tools, scene understanding models, or pre-trained detection systems—to assist with generating accurate and consistent annotations. For instance, the model(s) 126 may be used to automatically propose label candidates, enhance label quality, or perform inference-based contextual tagging based on patterns observed in the test data 132. The resulting ground truth data 134, in some instances, may be organized in accordance with the labeling specifications to support validation of the relevant safety goals. In some examples, a single test data sample may be labeled with multiple types of annotations to enable multi-goal evaluation. For example, one frame of sensor data may include pedestrian bounding boxes for collision avoidance goals, lane geometry for localization evaluation, and signal state information for assessing intersection compliance.

Referring back to FIG. 1, the process 100 may include the dataset generation system 102 outputting the safety dataset(s) 130, including the test data 132 and corresponding ground truth data 134. In some examples, the dataset generation system 102 may store or otherwise maintain the safety dataset(s) 130 in a secure database(s) or other environment (not shown). For instance, the safety dataset(s) 130 may be kept isolated from training data, and may be subject to access and modification controls to maintain its integrity. For instance, the dataset generation system 102 and/or the secure storage environment may restrict access to the safety dataset(s) 130 within a particular organization, and safety-related datasets may be access-controlled upon ingestion, allowing only designated teams—such as those responsible for safety validation—to use or view the data. In some examples, the dataset generation system 102 may implement a process to manage how and when information about the safety dataset(s) 130 is shared with other parts of the organization, helping to minimize the risk of unintentional reuse in training workflows and preserving the objectivity of the evaluation.

In various examples, the safety dataset(s) 130 may be provided to the test system(s) 104, and the test system(s) 104 may use the safety dataset(s) 130 to evaluate performance of a machine and/or subsystems or components of the machine. For instance, the test data 132 may be applied or replayed as inputs to the machine system(s) 106—which may include or correspond to perception systems, planning systems, control systems, or any other systems or components of a machine—as if the test data 132 were coming from live sensors. Response data 136 representing one or more outputs of the machine system(s) 106 may be sent to the test system(s) 104 and compared against the ground truth data 134 to determine whether the machine system(s) 106 performed correctly under the tested conditions. This evaluation may be used to determine whether the behavior of the machine system(s) 106 statistically satisfies the defined safety goals across the range of driving scenarios and ODD conditions included in the dataset, and the test system(s) 104 may output result data 138 representing these results.

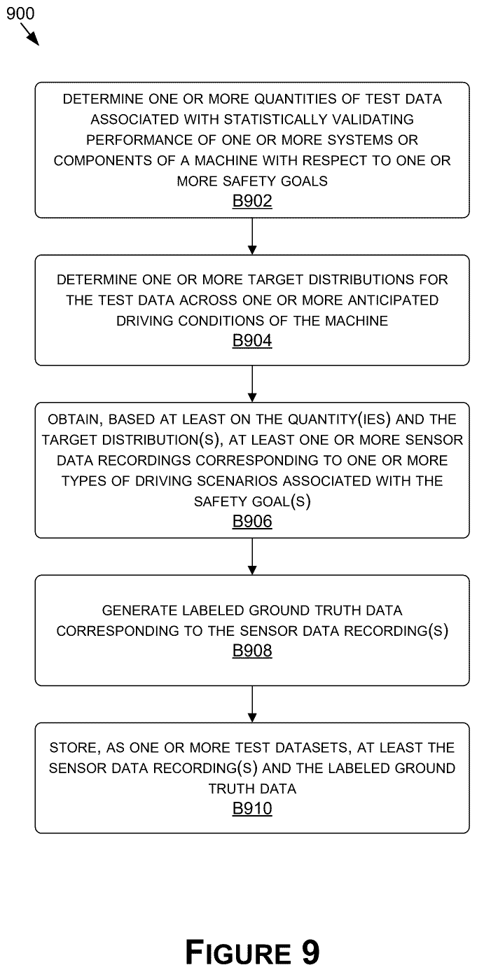

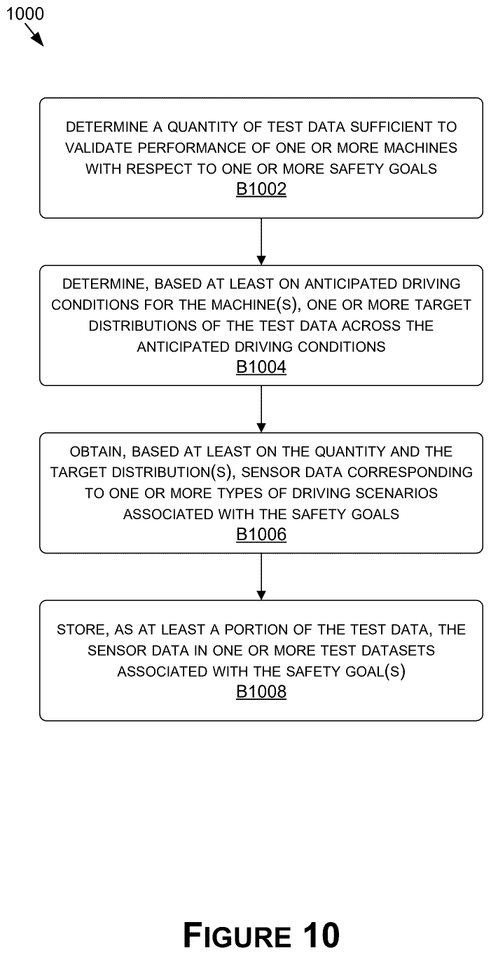

Now referring to FIGS. 9 and 10, each block of method 900 and 1000, described herein, comprises a computing process that may be performed using any combination of hardware, firmware, and/or software. For instance, various functions may be carried out using one or more processors (such as, but not limited to, those described herein) executing instructions stored in one or more memories or memory systems. In some embodiments, the computer processes may also be embodied as computer-usable instructions stored on computer storage media. The methods may be provided by a standalone application, a service or hosted service (standalone or in combination with another hosted service), an application programming interface (API) and/or a plug-in to another product, etc. In addition, methods 900 and 1000 are described, by way of example, with respect to FIGS. 1-8. However, these methods may additionally or alternatively be executed by any one system, or any combination of systems, including, but not limited to, those described herein.

FIG. 9 is a flow diagram illustrating an example of a method 900 for generating a safety test dataset, in accordance with some embodiments of the present disclosure. The method 900, at block B902, may include determining one or more quantities of test data associated with statistically validating performance of one or more systems or components of a machine with respect to one or more safety goals. For instance, the data quantity determiner 114 may determine and generate the quantity data 402 representing the quantity(ies) of the test data associated with statistically validating performance of the machine system(s) 106 with respect to one or more safety goals defined in the goal data 128. In some examples, the quantity(ies) of the data may be determined based on failure information determined from performing a fault tree analysis associated with the safety goal(s).

The method 900, at block B904, may include determining one or more target distributions for the test data across one or more anticipated driving conditions of the machine. For example, the distribution component 116 may determine and generate the distribution data 608 representing the target distribution(s) for the test data 132 across the anticipated driving condition(s).

The method 900, at block B906, may include obtaining, based at least on the quantity(ies) and the target distribution(s), at least one or more sensor data recordings corresponding to one or more types of driving scenarios associated with the safety goal(s). For instance, the test data obtainer 122 may obtain the sensor data 704 and/or 726 corresponding to the type(s) of driving scenario(s) associated with the safety goal(s).

The method 900, at block B908, may include generating labeled ground truth data corresponding to the sensor data recording(s). For instance, the labeler 120 may generate the ground truth data 134 corresponding to the test data 132, which may include the sensor data recording(s). The labeler 120 may generate the ground truth based on a label specification(s) associated with the safety goal(s).

The method 900, at block B910, may include storing, as one or more test datasets, at least the sensor data recording(s) and the labeled ground truth data. For instance, the dataset generation system 102 may store the test data 132 including the sensor data recording(s) and the ground truth data 134 as the safety dataset(s) 130. In some examples, the test dataset(s) may be stored in an access restricted location and maintained separate from training data or other developmental datasets for training the machine and/or subsystems of the machine.

FIG. 10 is a flow diagram illustrating an example of a method 1000 for obtaining test data for a safety test dataset, in accordance with some embodiments of the present disclosure. The method 1000, at block B1002, may include determining a quantity of test data sufficient to validate performance of one or more machines with respect to one or more safety goals. For example, the data quantity determiner 114 may determine and generate the quantity data 402 representing the quantity of the test data sufficient to validate the performance of the machine system(s) 106 with respect to the safety goal(s) defined in the goal data 128. In some examples, the quantity of the test data may be determined based on failure information determined from performing a fault tree analysis associated with the safety goal(s).

The method 1000, at block B1004, may include determining, based at least on anticipated driving conditions for the machine(s), one or more target distributions of the test data across the anticipated driving conditions. For example, the distribution component 116 may determine and generate the distribution data 608 representing the target distribution(s) for the test data 132 across the anticipated driving conditions.

The method 1000, at block B1006, may include obtaining, based at least on the quantity and the target distribution(s), sensor data corresponding to one or more types of driving scenarios associated with the safety goals. For instance, the test data obtainer 122 may obtain the sensor data 704 and/or 726 corresponding to the type(s) of the driving scenario(s) associated with the safety goals.

The method 1000, at block B1008, may include storing, as at least a portion of the test data, the sensor data in one or more test datasets associated with the safety goal(s). For example, the dataset generation system 102 may store the test data 132 including the sensor data and the ground truth data 134 as the safety dataset(s) 130. In some examples, the test dataset(s) may be stored in an access restricted location and maintained separate from training data or other developmental datasets for training the machine and/or subsystems of the machine.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models—such as large language models (LLMs), vision language models (VLMs), and/or multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### Example Autonomous or Semi-Autonomous Machine

FIG. 11A is an example of sensor locations having corresponding fields of view or sensory fields for an autonomous or semi-autonomous vehicle 1100a, an autonomous mobile robot (AMR) 1100b, and a humanoid robot 1100c, in accordance with some embodiments of the present disclosure. Although three types of machines 1100 are illustrated, this is not intended to be limiting, and the machine(s) 1100 described herein may include a vehicle, a car, a truck, a bus, a first responder vehicle, a shuttle, an electric or motorized bicycle, a motorcycle, a fire truck, a police or emergency vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers). The vehicle 1100a, AMR 1100b, humanoid robot 1100c, and/or other machine types may be referred to herein collectively as machine 1100, in some instances.

With respect to vehicles 1100A, autonomous and semi-autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The machine 1100 may be capable of functionality in accordance with one or more of Level 3-Level 5 of the autonomous driving levels. The machine 1100 may be capable of functionality in accordance with one or more of Level 1-Level 5 of the autonomous driving levels. For example, the machine 1100 may be capable of driver assistance (Level 1), partial automation (Level 2, Level 2+, Level 2++), conditional automation (Level 3), high automation (Level 4), and/or full automation (Level 5), depending on the embodiment. The term “autonomous,” as used herein, may include any and/or all types of autonomy for the machine 1100 or other machine, such as being fully autonomous, being highly autonomous, being conditionally autonomous, being partially autonomous, providing assistive autonomy, being semi-autonomous, being primarily autonomous, or other designation.

With respect to FIG. 11A, the sensors and their respective fields of view (not illustrated for clarity purposes) or sensory fields (not illustrated for clarity purposes) are one example embodiment and are not intended to be limiting. Although not illustrated, each sensor may have a corresponding field of view (e.g., a 360 degree field of view of a surround camera 1168D, a 180 degree field of view of a wide-view camera 1170, a 360 degree sensory field of a LiDAR sensor 1164, etc.). For example, only a subset of the sensors illustrated may be included, additional sensors may be included, alternative sensors may be included, the number of each sensor modality may differ, the sensor modalities may differ (e.g., may not include LiDAR or RADAR, may include SONAR, thermal sensors, etc.), the sensor locations may be different from those illustrated on the vehicle 1100a, AMR 1100b, and/or humanoid robot 1100c, etc. For example, with respect to the vehicle 1100a, depending on the type (e.g., SUV, truck, sedan, robot, motorcycle, etc.), size (e.g., 18-wheeler, moving van, small sedan, etc.), and related functionality (e.g., L2 vs. L5), the locations, numbers, modalities, and/or other sensor information may differ. Similarly, for the AMR 1100b and/or humanoid robot 1100c, the shape, size, purpose, implementation, model, etc. may dictate the number and types of sensors used.

As illustrated in FIG. 1A, the autonomous or semi-autonomous vehicle 1100A, the AMR 1100B, and the humanoid robot 1100C may include different sensor types, number, and locations. For a non-limiting example, the vehicle 1100A may include twelve cameras 1164, such as a front wide camera (e.g., 120 degree field of view (FOV)), a front telephoto camera (e.g., 30 degree FOV), a side rear left camera (e.g., 70 degree FOV), a side rear right camera (e.g., 70 degree FOV), a front fisheye camera (e.g., 200 degree FOV), a rear fisheye camera (e.g., 200 degree FOV), a left fisheye camera (e.g., 200 degree FOV), a right fisheye camera (e.g., 200 degree FOV), a front telephoto satellite camera (e.g., 30 degree FOV), a rear telephoto camera (e.g., 30 degree FOV), a cross left camera (e.g., 120 degree FOV), and a cross right camera (e.g., 120 degree FOV). The camera(s) 1164 may use, in embodiments, a gigabit multimedia serial link (GMSL) interface—such as GMSL2—as input/output (I/O).

In some embodiments, although not illustrated in FIG. 11A, the vehicle 1100A may include an in-cabin occupant and/or driver monitoring system, that may include various different sensors. For example, the in-cabin sensors may include various cameras 1168, such as a driver monitoring camera (e.g., 55 degree FOV positioned forward of and facing toward the driver seat), a front occupant monitoring camera (e.g., 190 degree FOV positioned forward of and facing the front occupant(s) seat(s)), and a rear occupant monitoring camera (e.g., 190 degrees positioned forward of and facing the rear occupant(s) seat(s)). Similar to the external facing camera(s) 1168, the internal camera(s) 1168 may, in embodiments, use a GMSL (such as GMSL2) interface for I/O.

As another non-limiting example, the vehicle 1100A may further include nine RADAR sensors 1160. For example, the vehicle 1100A may include a front center imaging RADAR sensor (e.g., 120 degree FOV or sensory field), a corner front left RADAR sensor (e.g., 160 degree FOV or sensory field), a corner front right RADAR sensor (e.g., 160 degree FOV or sensory field), a corner rear right RADAR sensor (e.g., 160 degree FOV or sensory field), a side left RADAR sensor (e.g., 160 degree FOV or sensory field), a side right RADAR sensor (e.g., 160 degree FOV or sensory field), a rear left RADAR sensor (e.g., 50 degree FOV or sensory field), and rear right RADAR sensor (e.g., 50 degree FOV or sensory field). The RADAR sensor(s) 1160 may use, in embodiments, an Ethernet interface as I/O.

The vehicle(s) 1100A may further include, as a non-limiting example, twelve ultrasonic sensors 1162. As illustrated in FIG. 11A, the ultrasonic sensors may be positioned along the front and rear bumpers of the vehicle 1100A, and along the side of the vehicle 1100A, and may be used to detect objects (static and dynamic) in close proximity to the vehicle 1100A. In some embodiments, the ultrasonic sensor(s) 1162 may use a DS13 interface as I/O.

The vehicle(s) 1100A may further include, as a non-limiting example, a LiDAR sensor 1164, such as a front center LiDAR sensor (e.g., 120 degree horizontal FOV or sensory field and 30 degree vertical FOV or sensor field). In some embodiments, such as where additional or alternative LiDAR sensors are used, the LiDAR sensor may have differing horizontal and vertical fields of view or sensory fields. For example, a LiDAR sensor 1164 may include a 360 degree horizontal FOV or sensory field (such as in a spinning LiDAR sensor) and a 90 degree vertical FOV or sensory field. In some embodiment, the LiDAR sensor(s) 1164 may use an Ethernet interface as I/O.

The autonomous mobile robot (AMR) 1100B may include, as a non-limiting example, three LiDAR sensors 1164. For example, the top-most illustrated LiDAR sensor 1164 may include a beam or 3D LiDAR sensor (e.g., 360 degree horizontal and 90 degree vertical FOV or sensory field), and the front and rear LiDAR sensors may include planar or 2D LiDAR sensors (e.g., 180 degree horizontal FOV or sensory field).

The AMR 1100B may further include, as a non-limiting embodiment, eight cameras 1168, such as a front stereo camera (e.g., 120 degree FOV), a rear stereo camera (e.g., 120 degree FOV), a left stereo camera (e.g., 120 degree FOV), a right stereo camera (e.g., 120 degree FOV), a front fisheye camera (e.g., 202 degree +−3 degree FOV), a rear fisheye camera (e.g., 202 degree +−3 degree FOV), a left fisheye camera (e.g., 202 degree +−3 degree FOV), and a right fisheye camera (e.g., 202 degree +−3 degree FOV).

The AMR 1100B may further include a charging port, charging port contacts, a status indicator light, one or more (e.g., four) RGB LEDs, one or more IMU sensors 1166, a magnetometer, and a barometer. The AMR 1100B is capable of high-precision time synchronization between sensors using hardware time stamping, and PTP over Ethernet with less than 10 microseconds for sensor acquisition time. The AMR 1100B provides simultaneous camera capture across all cameras 1168 within 100 microseconds from a single hardware trigger, in embodiments, and can write to disk at 4 GB/second for sensor capture to bag writing (e.g., writing to ROSbags for the robot operation system (ROS)). As such, the AMR 1100B is capable of running the ROS (such as NVIDIA's Isaac ROS), can be teleoperated (as described herein), can map an environment, and can navigate within an environment using visual cameras 1168, LiDARs 1164, and/or other sensor types or modalities.

The humanoid robot 1100C may include, as a non-limiting example, one LiDAR sensor 1164. For example, the LiDAR sensor 1164 may include a beam or 3D LiDAR sensor (e.g., 360 degree horizontal and 90 degree vertical FOV or sensory field), or may include a planar or 2D LiDAR sensor (e.g., 180 degree horizontal FOV or sensory field).

The humanoid robot 1100C may further include, as a non-limiting embodiment, four cameras 1168, such as a front stereo camera (e.g., 120 degree FOV), a rear stereo camera (e.g., 120 degree FOV), a front fisheye camera (e.g., 202 degree +−3 degree FOV), and a rear fisheye camera (e.g., 202 degree +−3 degree FOV).

The humanoid robot 1100C may further include, as a non-limiting embodiment, four ultrasonic sensors 1162, such as a left arm ultrasonic sensor, a right arm ultrasonic sensor, a left leg ultrasonic sensor, and right leg ultrasonic sensor.

The humanoid robot 1100C may further include any number of actuators—such as to allow control and maneuverability of joints. For example, the humanoid robot 1100C may include actuators that allow for various degrees of freedom (DoF) depending on the design. In a non-limiting embodiment, the humanoid robot 1100C may have 40 total degrees of freedom (DoF) (e.g., 6 DoF×2 for the arms, 6 DoF×2 for the hands, 6 DoF×2 for the legs, 2 DoF for the torso, and 2 DoF for the neck). The actuators may convert energy into physical motion, allowing for actions such as joint movements, locomotion, and gripping/manipulation. For example, joint movements may be performed using motors and servos to control the rotation of joints in an arm or manipulator, and to allow for reaching, grabbing, and manipulating objects. Locomotion may be accomplished using wheels, tracks, or other locomotion devices (robotic legs) to move around the environment. Gripping and manipulation may be performed using end-effectors or hands/fingers, which may be equipped with actuators to grip objects, apply force, and perform specific tasks. In some examples, the humanoid robot 1100C may include position and orientation sensors, such as encoders, gyroscopes, and the like, to determine the position of the robot 1100C in space, allowing for location determination and movement tracking. The humanoid robot 1100C may include force and pressure sensors, in embodiments, to detect environment interactions, allowing the robot 1100C to grasp objects with the right force and to avoid obstacles along the way. The perception sensors (e.g., cameras, LiDARs, RADARs, ultrasonic, SONAR, etc.) may be used along with tactile sensors to allow the robot 1100C to perceive objects, shapes, and textures, and to understand when touch is initiated and stopped (along with force sensors that regulate the force used during touch). As a non-limiting example, the humanoid robot 1100C may have a height of about 1-2 meters (e.g., 1.7 meters or 5′ 6″), a weight of 50-70 kg, be capable of moving at a speed of 8 or more km/h, and be able to carry payloads anywhere from 20-100 kg, depending on the design and requirements of the system.

The humanoid robot 1100C, in embodiments, may include a conversational system—such as a conversational system powered by language models (e.g., LLMs, VLMs, MMLMs, VLAs, etc.)—in order to help understand the environment, reason, and communicate with humans, animals, devices, and/or other robots, and/or make planning, control, and navigation decisions. As such, in addition to performing various tasks, the humanoid robot 1100C may use onboard sensors, microphones, and speakers to understanding speech, audio and visual cues, etc., while also being able to communicate back to the environment.

With reference to cameras 1168 of the machine(s) 1100, the camera types for the cameras 1168 may include, but are not limited to, digital cameras that may be adapted for use with the components and/or systems of the machine 1100. For a vehicle 1100a implementation, the camera(s) 1168 may operate at automotive safety integrity level (ASIL) B and/or at another ASIL. The camera types may be capable of any image capture rate, such as 30 frames per second (fps), 60 fps, 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

Cameras with a field of view that include portions of the environment in front of the machine 1100 (e.g., front-facing cameras) may be used for surround view, to help identify forward facing paths and obstacles, as well aid in, with the help of one or more controllers 1136 and/or control SoCs, providing information critical to generating an occupancy grid and/or determining the preferred machine movements, trajectories, and/or paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1168B that may be used to perceive objects coming into view from the periphery (e.g., pedestrians, warehouse vehicles, other robots, crossing traffic, or bicycles). In addition, any number of long-range camera(s) 1168E (e.g., a long-view stereo camera pair) may be used for depth-based object detection, especially for objects for which a neural network has not yet been trained. The long-range camera(s) 1168E may also be used for object detection and classification, as well as basic object tracking.

Any number of stereo cameras 1168A may also be included in a front-facing and/or other (e.g., rear-facing) configuration. In at least one embodiment, one or more of stereo camera(s) 1168A may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the machine's 1100 environment, including a distance estimate for points in the image (e.g., a disparity or depth image). An alternative stereo camera(s) 1168A may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1168A may be used in addition to, or alternatively from, those described herein. For example, in some embodiments, stereo depth estimation may be performed using other than stereo cameras, such as two monocular cameras having at least partially overlapping fields of view.

Cameras with a field of view that include portions of the environment to the side of the machine 1100 (e.g., side-view cameras) may be used, for example, for surround view, providing information used to create and update the occupancy grid, as well as to generate side impact collision warnings and/or to indicate to an AMR 1100B or humanoid robot 1100C, for example, that there are objects, features, and/or persons present to the side. For example, surround camera(s) 1168D may be positioned on the machine 1100. The surround camera(s) 1168D may include wide-view camera(s) 1168B, fisheye camera(s), 360 degree camera(s), and/or the like. For example, four fisheye cameras may be positioned on the machine's 1100 front, rear, and sides. In an alternative arrangement, the machine 1100 may use three surround camera(s) 1168D (e.g., left, right, and rear), and may leverage one or more other camera(s) (e.g., a forward-facing camera) as a fourth surround view camera.

Cameras 1168 with a field of view that include portions of the environment to the rear of the machine 1100 (e.g., rear-view cameras) may be used for gaining an understanding of objects, features, persons, and/or other information to the rear of the machine 1100, such as for park assistance, surround view, rear collision warnings, planning, control, and navigation determinations, and/or creating and updating an occupancy grid, BEV image representing the environment, height map, etc. A wide variety of cameras 1168 may be used including, but not limited to, cameras 1168 that are also suitable as a front-facing camera(s) (e.g., long-range and/or mid-range camera(s) 1168E, stereo camera(s) 1168A), infrared camera(s) 1168C, etc.), rear-facing camera(s), side-facing camera(s), downward facing camera(s), upward facing camera(s), and/or the like, as described herein.

Similarly, for LiDAR sensors 1164, RADAR sensors 1160, ultrasonic sensors 1162, and/or other sensor modalities or types, the location and placement of the sensors, and their corresponding fields of view or sensory fields may be determined based on the use case, implementation, or design of the particular machine 1100.

For example, the machine(s) 1100 include RADAR sensor(s) 1160 that may be used by the machine 1100 for long-range object detection, even in darkness and/or severe weather conditions. RADAR functional safety levels may be ASIL B, in embodiments. The RADAR sensor(s) 1160 may use the CAN and/or the bus 1102 (e.g., to transmit data generated by the RADAR sensor(s) 1160) for control and to access object tracking data, with access to Ethernet to access raw data in some examples. A wide variety of RADAR sensor types may be used. For example, and without limitation, the RADAR sensor(s) 1160 may be suitable for front, rear, and side RADAR use. In some example, Pulse Doppler RADAR sensor(s) are used.

The RADAR sensor(s) 1160 may include different configurations, such as long range with narrow field of view, short range with wide field of view, short range side coverage, etc. In some examples, long-range RADAR may be used for adaptive cruise control (ACC) functionality. The long-range RADAR systems may provide a broad field of view realized by two or more independent scans, such as within a 250 m range. The RADAR sensor(s) 1160 may help in distinguishing between static and moving objects, and may be used by ADAS systems for emergency brake assist and forward collision warning, by robots for detecting dynamic objects in various environments—such as those with lower or no lighting. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the machine's 1100 surroundings at higher speeds with minimal interference from the periphery (e.g., from traffic in adjacent lanes). The other two antennae may expand the field of view, making it possible to quickly detect objects entering or leaving the machine's immediate path (e.g., lane).

Mid-range RADAR systems may include, as an example, a range of up to 1160 m (front) or 80 m (rear), and a field of view of up to 42 degrees (front) or 150 degrees (rear). Short-range RADAR systems may include, without limitation, RADAR sensors designed to be installed at both ends of a lateral surface (e.g., a rear bumper) such that two beams may be used to constantly monitor the blind spot in the rear and next to the machine 1100 (e.g., vehicle, robot, etc.). As such, short-range RADAR systems may be used in an ADAS system for blind spot detection and/or lane change assist.

The machine 1100 may further include ultrasonic sensor(s) 1162. The ultrasonic sensor(s) 1162, which may be positioned at the front, back, and/or the sides of the machine 1100, may be used for assisting with near-field perception, such as for park assist, collision avoidance (e.g., for robotic parts), and/or to create and update an occupancy grid, evidence grid map (EGM), height map, BEV image, and/or other representation of objects and features in an environment of the machine 1100. A wide variety of ultrasonic sensor(s) 1162 may be used, and different ultrasonic sensor(s) 1162 may be used for different ranges of detection (e.g., 2.5 m, 4 m). The ultrasonic sensor(s) 1162 may operate at functional safety levels of ASIL B, as an example.

The machine 1100 may include LiDAR sensor(s) 1164. The LiDAR sensor(s) 1164 may be used for object and feature detection, pedestrian and other robot detection, emergency braking, collision avoidance, simultaneous localization and mapping (SLAM), free-space detection, and/or other functions. The LiDAR sensor(s) 1164 may be functional safety level ASIL B, in embodiments. In some examples, the machine 1100 may include multiple LiDAR sensors 1164 (e.g., two, four, six, etc.) that may use Ethernet (e.g., to provide data to a Gigabit Ethernet switch).

In some examples, the LiDAR sensor(s) 1164 may be capable of providing a list of objects and their distances for a 360-degree field of view. Commercially available LiDAR sensor(s) 1164 may have an advertised range of approximately 1100 m, with an accuracy of 2 cm-3 cm, and with support for a 1100 Mbps Ethernet connection, for example. In some examples, one or more non-protruding LiDAR sensors 1164 may be used. In such examples, the LiDAR sensor(s) 1164 may be implemented as a small device that may be embedded into the front, rear, sides, top, and/or corners of the machine 1100. The LiDAR sensor(s) 1164, in such examples, may provide up to a 120-degree horizontal and 35-degree vertical field-of-view, with a 200 m range even for low-reflectivity objects. Front-mounted LiDAR sensor(s) 1164 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the machine 1100. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 1164 may be less susceptible to motion blur, vibration, and/or shock.

FIG. 11B is an illustration of sensor and component locations of an example autonomous or semi-autonomous vehicle 1100A (alternatively referred to herein as “vehicle 1100,” “ego-vehicle 1100,” “ego-machine 1100,” or “machine 1100,”), in accordance with some embodiments of the present disclosure. Although the vehicle 1100A is illustrated, this is not intended to be limiting, and similar components and/or sensors may be included on any other machine type without departing from the scope of the present disclosure. For example, similar sensors and/or components may be used for a vehicle, a car, a truck, a bus, a first responder vehicle, a shuttle, an electric or motorized bicycle, a motorcycle, a fire truck, a police vehicle, an ambulance, a watercraft, a construction vehicle, an underwater craft, a robot (e.g., AMR, humanoid, robotic arm, end-effector, forklift, etc.), a drone, an aircraft, a vehicle coupled to a trailer (e.g., a semi-tractor-trailer truck used for hauling cargo), and/or another type of vehicle or machine (e.g., that is unmanned and/or that accommodates one or more passengers).

FIG. 11C is a block diagram of an example system architecture for a machine 1100, such as autonomous or semi-autonomous vehicle 1100A, autonomous mobile robot (AMR) 1100B, humanoid robot 1100C, and/or other types of machines, in accordance with some embodiments of the present disclosure. It should be understood that this and other arrangements described herein are set forth only as examples. Other arrangements, components, features, and elements (e.g., machines, interfaces, functions, orders, groupings of functions, etc.) may be used in addition to or instead of those shown, and some elements may be omitted altogether. Further, many of the arrangements, components, features, elements, etc. described herein are functional entities that may be implemented as discrete or distributed components or in conjunction with other components, and in any suitable combination and location (e.g., on a local device, vehicle, or machine at the edge, on-premises—such as locally hosted servers, remotely located—such as in one or more computing or server devices in one or more data centers in the cloud, and/or at other locations). Various functions described herein as being performed by entities may be carried out by hardware, firmware, and/or software. For instance, various functions may be carried out using one or more processors (e.g., central processing units (CPU(s)), graphics processing units (GPU(s)), microprocessors, microcontrollers, embedded processors, digital signal processors (DSPs), image signal processors (ISPs), physics processing units (PPUs), field-programmable gate arrays (FPGAs), accelerator(s) (e.g., deep learning accelerators (DLAs, deep learning accelerator cluster (XNNs), neural network accelerators (NNAs), and/or neural processing units (NPUs), programmable vision accelerators (PVAs), optical flow accelerators (OFAs), etc.), application-specific integrated circuits (ASICs), data processing units (DPUs), quantum processors, etc.) executing instructions stored in memory. In some embodiments, the systems, methods, and processes described herein may be executed using similar components, features, and/or functionality to those of example machine 1100 of FIGS. 11A-11E, example computing ecosystem 1200 of FIG. 12, example generative language model system 1300 of FIG. 13, and/or example computing device 1400 of FIG. 14.

Each of the components, features, and systems of the machine 1100 in FIG. 11C are illustrated as being connected via bus 1102 (alternatively referred to as a “machine communications network 1102,” or just “communications network 1102”). The bus 1102 may include a Controller Area Network (CAN) data interface (alternatively referred to herein as a “CAN bus”). A CAN may be a network inside the machine 1100 used to aid in control of various features and functionality of the machine 1100, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant. In some embodiments, in addition to or alternatively from a CAN bus, the bus 1102 may include FlexRay, an embedded bus (e.g., SPI, I2C), local interconnect link (LIN), NVIDIA's NVLink, USB (2.0, 3.0, onward), radio frequency (RF), Ethernet (e.g., 10BASE/100BASE, 1000BASE, 10G, etc.), and/or another communication protocol or functionality. Additionally, although a single line is used to represent the bus 1102, this is not intended to be limiting. For example, there may be any number of busses 1102, which may include one or more CAN busses, one or more FlexRay busses, one or more Ethernet busses, and/or one or more other types of busses using a different protocol. In some examples, two or more busses 1102 may be used to perform different functions, and/or may be used for redundancy. For example, a first bus 1102 may be used for collision avoidance functionality and a second bus 1102 may be used for actuation control. In any example, each bus 1102 may communicate with any of the components of the machine 1100, and two or more busses 1102 may communicate with the same components. In some examples, each SoC 1104, each controller 1136, and/or each computer or compute engine within the machine 1100 may have access to the same input data (e.g., inputs from sensors of the machine 1100), and may be connected to a common bus, such as a CAN bus.

The machine 1100 may include components such as a chassis, a vehicle body, wheels (e.g., 2, 4, 6, 8, 18, etc.), tires, axles, batteries, side-view mirrors, and/or other components of a vehicle or machine. The machine 1100 may include a propulsion system 1150, such as an internal combustion engine, hybrid electric power plant, an all-electric engine, a hydrogen-fueled engine, and/or another propulsion system type. The propulsion system 1150 may be connected to a drive train of the machine 1100, which may include a transmission, to enable the propulsion of the machine 1100. The propulsion system 1150 may be controlled in response to receiving signals from the throttle/accelerator 1152.

A steering system 1154, which may include a steering wheel and/or other steering device (e.g., remote steering and/or local steering), may be used to steer the machine 1100 (e.g., along a desired path or route) when the propulsion system 1150 is operating (e.g., when the vehicle is in motion). The steering system 1154 may receive signals from a steering actuator 1156. In some embodiments, a steering wheel or other steering mechanism may not be included, such as for a machine 1100 capable of full automation (e.g., Level 5) functionality.

The brake sensor system 1146 may be used to operate the vehicle brakes in response to receiving signals from the brake actuators 1148 and/or brake sensors.

The machine 1100 may include one or more controller(s) 1136, such as those described herein with respect to FIG. 11A. The controller(s) 1136 may be used for a variety of functions, and may be coupled to any of the various other components and systems of the machine 1100. For example, the controllers 1136 may be used for control of the machine 1100, artificial intelligence executing on the machine 1100, infotainment for the machine 1100, and/or the like. For example, one controller 1136 may be used for some or all of the functionality, or different controllers 1136 may be used for different functionalities—e.g., to ensure availability and a safety separation between various controllers for different tasks. For example, the controller(s) 1136 may use plans computed by the system—e.g., paths or trajectories for vehicles 1100A or AMRs 1100B, or movements, components trajectories, movement locations or displacements, etc. for joints or components (e.g., of manipulators, end effectors, limbs, hands, fingers, legs, feet, etc.), of a humanoid robot 1100C—to control the machine(s) 1100 in the environment. In some instances, the controller(s) 1136 may include a proportional-integral-derivative (PID) controller, a fuzzy logic controller, a neural controller (e.g., a controller embodied as one or more neural networks), a force control controller, a programmable logic controller (PLC), and/or another type of controller. In a humanoid robot 1100C, for example, the controller(s) 1136 may act as the brain, responsible for analyzing sensor data, making decisions, and sending commands to the actuators. The controller(s) 1136 may include a low-level controller that handles basic motor control, ensuring accurate and precise movements of individual joints and actuators. The controller(s) 1136 may include a high-level controller to coordinate multiple actuators and sensors, planning complex motions and adapting to changing environments.

The controller(s) 1136 may include an artificial intelligence controller, in embodiments, that may use AI algorithms (e.g., DNNs, MLMs, etc.) to learn, make decisions, and autonomously perform tasks for the machine 1100. In some embodiments, the controller(s) 1136 may use an open-loop control algorithm that is fixed and does not adjust actions to the environment. In other embodiments, closed-loop control may be used that incorporates feedback mechanisms to monitor the robot's performance and make necessary adjustments. In examples, the controller(s) 1136 may implement reactive control in order to respond directly to sensory inputs, allowing for quick reflexes and real-time changes. Further, deliberative control may be implemented in some examples, using internal models and planning algorithms to generate high-level actions, which may be suited for complex tasks that require reasoning, decision making, and long-term planning.

Controller(s) 1136, which may include one or more systems on chip (SoCs) 1104 (FIGS. 11C and 11D), CPUs, GPU(s), accelerator(s), etc., may provide signals (e.g., representative of commands or messages) to one or more components and/or systems of the machine 1100. Although the controller(s) 1136 is listed separately from the SoC(s) 1104, this is not intended to be limiting, and in some embodiments one or more components of the SoC(s) 1104 may perform the operations of the controller(s) 1136. For example, the controller(s) may send signals to operate the machine brakes via one or more brake actuators 1148, to operate the steering system 1154 via one or more steering actuators 1156, to operate the propulsion system 1150 via one or more throttle/accelerators 1152, etc. The controller(s) 1136 may include one or more onboard (e.g., integrated) computing devices (e.g., supercomputers) that process sensor signals, and output operation commands (e.g., signals representing commands) to enable autonomous or semi-autonomous navigation and movement and/or to assist a human operator using the machine 1100. The controller(s) 1136 may include a first controller 1136 for autonomous control and navigation functions, a second controller 1136 for functional safety functions, a third controller 1136 for artificial intelligence functionality (e.g., computer vision), a fourth controller 1136 for infotainment functionality, a fifth controller 1136 for redundancy in emergency conditions, and/or other controllers. For example, the hardware used for safety monitoring and other safety functions (such as a functional safety island) may be discrete or partitioned (physically or via separation of processing) with respect to hardware used for processing sensor data for perception and making vehicle control decisions. Similarly, hardware (e.g., a controller, an SOC, etc.) for controlling in-vehicle infotainment and/or in-cabin monitoring may be discrete or separate from the hardware used for vehicle perception and control. In some examples, a single controller 1136 may handle two or more of the above functionalities, two or more controllers 1136 may handle a single functionality, and/or any combination thereof.

The controller(s) 1136 may provide the signals for controlling one or more components and/or systems of the machine 1100 in response to sensor data received from one or more sensors (e.g., sensor inputs). The sensor data may be received from, for example and without limitation, global navigation satellite systems (“GNSS”) sensor(s) 1158 (e.g., Global Positioning System sensor(s)), RADAR sensor(s) 1160, ultrasonic sensor(s) 1162, LiDAR sensor(s) 1164, inertial measurement unit (IMU) sensor(s) 1166 (e.g., accelerometer(s), gyroscope(s), magnetic compass(es), magnetometer(s), etc.), microphone(s) 1196, camera(s) 1168 (e.g., stereo camera(s) 1168A, wide-view camera(s) 1168B (e.g., fisheye cameras), infrared camera(s) 1168C, surround camera(s) 1168D (e.g., 360 degree cameras), long-range and/or mid-range camera(s) 1168E, and/or other camera types), speed sensor(s) 1144 (e.g., for measuring the speed of the machine 1100), vibration sensor(s) 1142, steering sensor(s) 1140, brake sensor(s) (e.g., as part of the brake sensor system 1146), actuators, and/or other sensor types.

One or more of the controller(s) 1136 may receive inputs (e.g., represented by input data) from an instrument cluster 1132 of the machine 1100 and provide outputs (e.g., represented by output data, display data, etc.) via a human-machine interface (HMI) display 1134 (e.g., screen, heads-up display, mirror display, facial display, robotic display, etc.), an audible annunciator, a loudspeaker, a speaker, and/or via other components of the machine 1100. The outputs may include information such as machine velocity, speed, time, map data corresponding to a map(s) 1122 of FIG. 11C (e.g., from a navigation map, a Standard Definition (SD) map, a High Definition (“HD”) map, etc.), location data (e.g., the machine's 1100 location, such as on a map 1122), direction, location of other vehicles (e.g., an occupancy map, height map, bird's eye view (BEV) image, grid, etc.), information about objects and status of objects as perceived by the system, system status information, etc. For example, the HMI display(s) 1134 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The machine 1100 may include one or more systems on a chip (SoCs) 1104 (described in more detail in FIG. 11D). The SoC(s) 1104 may include CPU(s) 1106, GPU(s) 1108, processor(s) 1110, cache(s) 1112, accelerator(s) 1114, data store(s) 1116, and/or other components and features. The SoC(s) 1104 may be used to process and provide data for various operations, such as navigation, planning, reasoning, inference, perception, control, and/or actuation operations of the machine 1100 in a variety of platforms and systems. For example, the SoC(s) 1104 may process live perception data (e.g., from camera, LiDAR, RADAR, ultrasonic, etc.) in addition to map data corresponding to one or more maps 1122 (e.g., HD map, SD map, navigational map, occupancy map, etc.) in order to make or aid in performing various operations of the machine 1100. Where a map and/or AI is used, map and/or AI (e.g., model parameter updates, fine-tuning, etc.) refreshes and/or updates via a network interface 1124 from one or more servers (e.g., server(s) 1178 of FIG. 11E)—such as one or more servers of a cloud-based data center.

Although an SoC(s) 1104 is illustrated throughout FIGS. 11A-11E, additional or alternative components and/or architectures may be used—such as multi-chip modules (MCMs), application-specific integrated circuits (ASICs), system-in-packages (SiPs), field programmable gate arrays (FPGAs), heterogeneous integration (HI), single-board computers (SBCs)—without departing from the scope of the present disclosure. For example, depending on the type of machine 1100, use of the machine 1100, model of the machine 1100, and required capabilities of the machine 1100, one or more SoCs 1104 and/or alternative architectures and/or components may be used to satisfy the particular implementation.

The machine 1100 may include a CPU(s) 1118 (e.g., discrete CPU(s), or dCPU(s)), that may be coupled to the SoC(s) 1104 via a high-speed interconnect (e.g., PCIe). The CPU(s) 1118 may include an X86 processor, for example. The CPU(s) 1118 may be used to perform any of a variety of functions, including arbitrating potentially inconsistent results between ADAS sensors and the SoC(s) 1104, and/or monitoring the status and health of the controller(s) 1136 and/or infotainment SoC 1130, for example.

The machine 1100 may include a GPU(s) 1120 (e.g., discrete GPU(s), or dGPU(s)), that may be coupled to the SoC(s) 1104 via a high-speed interconnect (e.g., NVIDIA's NVLink). The GPU(s) 1120 may provide additional artificial intelligence functionality, such as by executing redundant and/or different neural networks, and may be used to train and/or update neural networks based on input (e.g., sensor data) from sensors of the machine 1100.

The machine 1100 may further include the network interface 1124 which may include one or more wireless antennas 1126 and/or modems (e.g., one or more wireless antennas for different communication protocols, such as a cellular antenna, a Bluetooth antenna, etc.). The network interface 1124 may be used to enable wireless connectivity over the Internet with the cloud (e.g., with the server(s) 1178 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the machine 1100 information about vehicles in proximity to the machine 1100 (e.g., vehicles in front of, on the side of, and/or behind the machine 1100). This functionality may be part of a cooperative adaptive cruise control functionality of the machine 1100.

The network interface 1124 may include a SoC that provides modulation and demodulation functionality and enables the controller(s) 1136 to communicate over wireless networks. The network interface 1124 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. For example, the network interface 1124 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), fifth generation of mobile communications technology (5G), sixth generation of mobile communications technology (6G), and/or other cellular and/or wireless communication standards. The wireless antenna(s) 1126 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

The machine 1100 may further include data store(s) 1128 which may include off-chip (e.g., off the SoC(s) 1104) storage. The data store(s) 1128 may include one or more storage elements including RAM, SRAM, DRAM, VRAM, Flash, hard disks, and/or other components and/or devices that may store at least one bit of data.

The machine 1100 may further include GNSS sensor(s) 1158. The GNSS sensor(s) 1158 (e.g., GPS, assisted GPS sensors, differential GPS (DGPS) sensors, etc.), to assist in mapping, perception, occupancy grid generation, and/or path planning functions. Any number of GNSS sensor(s) 1158 may be used, including, for example and without limitation, a GPS using a USB connector with an Ethernet to Serial (RS-232) bridge.

The machine 1100 may further include IMU sensor(s) 1166. The IMU sensor(s) 1166 may be located at a center of the rear axle of the machine 1100, in some examples. The IMU sensor(s) 1166 may include, for example and without limitation, an accelerometer(s), a magnetometer(s), a gyroscope(s), a magnetic compass(es), and/or other sensor types. In some examples, such as in six-axis applications, the IMU sensor(s) 1166 may include accelerometers and gyroscopes, while in nine-axis applications, the IMU sensor(s) 1166 may include accelerometers, gyroscopes, and magnetometers.

In some embodiments, the IMU sensor(s) 1166 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1166 may enable the machine 1100 to estimate heading without requiring input from a magnetic sensor by directly observing and correlating the changes in velocity from GPS to the IMU sensor(s) 1166. In some examples, the IMU sensor(s) 1166 and the GNSS sensor(s) 1158 may be combined in a single integrated unit.

The vehicle may include one or more microphone 1196 placed in and/or around the machine 1100. The microphone(s) 1196 may be used for emergency vehicle detection and identification, among other things.

The machine 1100 may further include vibration sensor(s) 1142. The vibration sensor(s) 1142 may measure vibrations of components of the machine, such as the arms or legs of a humanoid robot 1100C, or the axle(s) of a vehicle 1100A or AMR 1100B. For example, changes in vibrations may indicate a change in road, walking, or traversable surfaces. In another example, when two or more vibration sensors 1142 are used, the differences between the vibrations may be used to determine friction or slippage of the surface (e.g., when the difference in vibration is between a power-driven axle and a freely rotating axle).

The machine 1100 may include an ADAS system 1138—such as when the machine 1100 is a vehicle 1100A. The ADAS system 1138 may include a dedicated SoC(s), in some examples. The ADAS system 1138 may include autonomous/adaptive/automatic cruise control (ACC), cooperative adaptive cruise control (CACC), forward crash or collision warning (FCW), automatic emergency braking (AEB), lane departure warning (LDW), lane keep assist (LKA), blind spot warning (BSW), blind spot monitoring (BSM), rear cross-traffic warning (RCTW), pedestrian detection, driver monitoring, collision warning systems (CWS), traffic sign recognition, speed limit detection, automatic parking, lane centering (LC), high beam safety system, and/or other features and functionality.

The machine 1100 may further include the infotainment SoC 1130 (e.g., an in-vehicle infotainment system (IVI)). Although illustrated and described as a SoC, the infotainment system may not be an SoC, and may include one or more discrete components, such as multi-chip modules (MCMs), application-specific integrated circuits (ASICs), system-in-packages (SiPs), heterogeneous integration (HI), single-board computers (SBCs), etc. The infotainment SoC 1130 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., wireless, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the machine 1100. For example, the infotainment SoC 1130 may radios, disk players, navigation systems, video players, USB and Bluetooth connectivity, carputers, in-car entertainment, Wi-Fi, steering wheel audio controls, hands free voice control, a heads-up display (HUD), an HMI display 1134, a telematics device, a control panel (e.g., for controlling and/or interacting with various components, features, and/or systems), and/or other components. The infotainment SoC 1130 may further be used to provide information (e.g., visual and/or audible) to a user(s) of the vehicle, such as information from the ADAS system 1138, autonomous driving information such as planned vehicle maneuvers, trajectories, surrounding environment information (e.g., intersection information, vehicle information, road information, etc.), and/or other information.

The infotainment SoC 1130 may include GPU functionality. The infotainment SoC 1130 may communicate over the bus 1102 (e.g., CAN bus, Ethernet, etc.) with other devices, systems, and/or components of the machine 1100. In some examples, the infotainment SoC 1130 may be coupled to a supervisory MCU such that the GPU of the infotainment system may perform some self-driving functions in the event that the primary controller(s) 1136 (e.g., the primary and/or backup computers of the machine 1100) fail. In such an example, the infotainment SoC 1130 may put the machine 1100 into a chauffeur to safe stop mode, as described herein.

In some embodiments, the infotainment system may provide a digital or virtual assistant, that may be voice only, or may have a visual component (e.g., in the form of a digital human or digital avatar). The assistant may provide basic functions, like texting, adjusting vehicle settings, music or video control, navigation features, etc., and/or may provide more advanced features such as those supported by one or more language models—such as large language models (LLMs), vision language models (VLMs), multi-modal language models (MMLMs), etc. For example, the driver and/or occupants may be able to interact with the assistant similar to how a user may interact with a language model, such as to ask general questions, specific questions, to request restaurant, gas station, and/or other recommendations and/or locations, to learn about the vehicle functionality or troubleshooting (e.g., to ask tire pressure information, oil change information, battery exchange information, etc.). As such, the machine 1100—whether a vehicle 1100A, AMR 1100B, humanoid robot 1100C, and/or other type of machine—may include a locally stored language model(s) and/or communicate to a remotely hosted language model (e.g., via one or more APIs) to provide more detailed and in-depth communication features to the users of the machine(s) 1100.

In some examples, an infotainment SoC 1130, the SoC(s) 104, and/or another SoC or computing/processing system may perform in-cabin driver and/or occupant monitoring. For example, the computing system may perform facial recognition and vehicle owner identification may use data from camera and/or other sensors to identify the presence of an authorized driver and/or owner of the machine 1100. The always on sensor processing engine may be used to unlock the vehicle when the owner approaches the driver door and turn on the lights, and, in security mode, to disable the vehicle when the owner leaves the vehicle. In this way, the SoC(s) 1104 provide for security against theft and/or carjacking.

In some embodiments, an in-cabin monitoring camera sensor may be monitored using one or more neural networks running on another or dedicated SoC—such as an in-vehicle infotainment or in-vehicle monitoring SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. The in-cabin system may further include one or more in-cabin AI agents or assistants, which may use one or more APIs or plug-ins to interact with one or more LLMs, VLMs, MMLMs, etc. in the cloud. For example, the in-cabin AI agents or assistants may provide directions, vehicle or machine feedback information, answer general questions, handle music/video and/or other requests, activate windows, doors, and/or other vehicle components, etc. As such, one or more dedicated SoCs and/or sets of processors may be used to perform the in-cabin infotainment and/or in-cabin monitoring (e.g., as an occupant monitoring system (OMS)) for the machine 1100.

The machine 1100 may further include an instrument cluster 1132 (e.g., a digital dash, an electronic instrument cluster, a digital instrument panel, etc.). The instrument cluster 1132 may include a controller and/or supercomputer (e.g., a discrete controller or supercomputer). The instrument cluster 1132 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1130 and the instrument cluster 1132. In other words, the instrument cluster 1132 may be included as part of the infotainment SoC 1130, or vice versa.

FIG. 11D is a block diagram of an example architecture of a computing system (a subset of the system described with respect to FIG. 11C), in accordance with at least some embodiments of the present disclosure. Although illustrated as an SoC(s) 1104, this is not intended to be limiting, and the computing system may additionally or instead include multi-chip modules (MCMs), application-specific integrated circuits (ASICs), system-in-packages (SiPs), heterogeneous integration (HI), single-board computers (SBCs), and/or other components and/or architectures, without departing from the scope of the present disclosure.

The SoC(s) 1104 may be an end-to-end platform with a flexible architecture that spans automation levels 2-5, or the SoC(s) 1104 may be specifically designed for a specific automation level (e.g., a first SoC 1104 for level 2 to level 2++, a second SoC 1104 for level 3, a third SoC 1104 for level 4, etc.), thereby providing a comprehensive functional safety architecture that leverages and makes efficient use of computer vision, neural network inferencing, robotic planning, control, and navigation, ADAS techniques, and the like, with diversity and redundancy, to provide a platform for a flexible, reliable driving or robotic control software stack, along with deep learning tools. The SoC(s) 1104 may be faster, more reliable, and even more energy-efficient and space-efficient than conventional systems. For example, the accelerator(s) 1114, when combined with the CPU(s) 1106, the GPU(s) 1108, and the data store(s) 1116, may provide for a fast, efficient platform for level 2-5 autonomous vehicles as well as for safe planning, navigation, and control of AMRs 1100B, humanoid robots 1100C, and/or other robot or machine types.

In some embodiments, such as where the SoC(s) 1104 include a GPU 1108 with 2000 or more cores (e.g., 2048 cores), 60 or more tensor cores (e.g., 64 tensor cores), and a GPU max frequency of over 1 GHz (e.g., 1.3 GHz), a CPU 1106 including 10 or more cores (e.g., 12 cores), with 64 bits, 3 MB L2 and 6 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 1109 (e.g., 2 DLAs/XNNs/NNAs/NPUs 1109), and a vision accelerator-such as a programmable vision accelerator (PVA) 1107, a single SoC 1104) may be capable of 275 tera operations per second (TOPS) of AI performance. For example, NVIDIA's Jetson AGX Orin 64 GB SoC satisfies these criteria, and achieves this performance.

Similarly, in embodiments where the SoC(s) 1104 include a GPU 1108 with 1700 or more cores (e.g., 1792 cores), 50 or more tensor cores (e.g., 56 tensor cores), and a GPU max frequency of over 900 MHz (e.g., 930 MHz), a CPU 1106 including 8 or more cores (e.g., 8 cores), with 64 bits, 2 MB L2 and 4 MB L3 cache memory, and a max frequency of 2 or more GHz (e.g., 2.2 GHz), one or more deep learning accelerators (DLAs), deep learning accelerator clusters (XNNs), neural network accelerators (NNAs), or neural processing units (NPUs) 1109 (e.g., 2 DLAs/XNNs/NNAs/NPUs 1109), and a vision accelerator—such as a programmable vision accelerator (PVA) 1107, a single SoC 1104) may be capable of 200 tera operations per second (TOPS) of AI performance. For example, NVIDIA's Jetson AGX Orin 32 GB SoC satisfies these criteria, and achieves this performance.

In some embodiments, such as where the SoC(s) 1104 include a GPU 1108 with 1000 or more cores (e.g., 1024 cores), 28 or more tensor cores (e.g., 32 tensor cores), and a GPU max frequency of over 900 MHz (e.g., 1173 MHz), a CPU 1106 including 8 or more cores (e.g., 8 cores), with 64 bits, 2 MB L2 and 4 MB L3 cache memory, and a max frequency of 2 or more GHz (e.g., 2 GHz), one or more deep learning accelerators (DLAs), deep learning accelerator clusters (XNNs), neural network accelerators (NNAs), or neural processing units (NPUs) 1109 (e.g., 1 DLA/XNN/NNA/NPU 1109), and a vision accelerator—such as a programmable vision accelerator (PVA) 1107, a single SoC 1104) may be capable of 157 tera operations per second (TOPS) of AI performance. For example, NVIDIA's Jetson AGX Orin NX 16 GB SoC satisfies these criteria, and achieves this performance.

In various embodiments, such as where the SoC(s) 1104 include a GPU 1108 with 1000 or more cores (e.g., 1024 cores), 28 or more tensor cores (e.g., 32 tensor cores), and a GPU max frequency of over 900 MHz (e.g., 1020 MHz), a CPU 1106 including 6 or more cores (e.g., 6 cores), with 64 bits, 1.5 MB L2 and 4 MB L3 cache memory, and a max frequency of 1.5 or more GHz (e.g., 1.7 GHz), a single SoC 1104) may be capable of 67 tera operations per second (TOPS) of AI performance. For example, NVIDIA's Jetson Orin Nano 8 GB SoC satisfies these criteria, and achieves this performance.

The SoC(s) 1104 may include one or more CPUs 1106. The CPU(s) 1106 may include a CPU cluster or CPU complex (alternatively referred to herein as a “CCPLEX”), in embodiments. The CPU(s) 1106 may include multiple cores and/or (e.g., L2, L3) caches. For example, in some embodiments, the CPU(s) 1106 may include twelve cores in a coherent multi-processor configuration. In some embodiments, the CPU(s) 1106 may include four dual-core clusters where each cluster has a dedicated L2 cache (e.g., a 3 MB L2 cache). The CPU(s) 1106 (e.g., the CCPLEX) may be configured to support simultaneous cluster operation enabling any combination of the clusters of the CPU(s) 1106 to be active at any given time.

The SoC(s) 1104 may include any type and number of GPUs 1108. For example, an integrated GPU(s) (alternatively referred to herein as an “iGPU(s)”) may be used in some embodiments. The GPU(s) 1108 may be programmable and may be efficient for parallel workloads. The GPU(s) 1108, in some examples, may use an enhanced tensor instruction set. The GPU(s) 1108 may include one or more streaming microprocessors, where each streaming microprocessor may include a cache (e.g., an L1 cache with at least 96 KB storage capacity), and two or more of the streaming microprocessors may share an L2 cache (e.g., an L2 cache with a 512 KB storage capacity). In some embodiments, the GPU(s) 1108 may include at least eight streaming microprocessors. The GPU(s) 1108 may use compute application programming interface(s) (API(s)). In addition, the GPU(s) 1108 may use one or more parallel computing platforms and/or programming models (e.g., NVIDIA's CUDA).

The GPU(s) 1108 may be power-optimized for best performance in automotive, robotics, and/or other embedded use cases. For example, the GPU(s) 1108 may be fabricated on a Fin field-effect transistor (FinFET). However, this is not intended to be limiting and the GPU(s) 1108 may be fabricated using other semiconductor manufacturing or fabrication processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an (e.g., L0) instruction cache, a warp scheduler, a dispatch unit, and/or a (e.g., 64 KB) register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1108 may include a high bandwidth memory (HBM) and/or a (e.g., 16 GB) HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1108 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1108 to access the CPU(s) 1106 page tables directly. In such examples, when the GPU(s) 1108 memory management unit (MMU) experiences a miss, an address translation request may be transmitted to the CPU(s) 1106. In response, the CPU(s) 1106 may look in its page tables for the virtual-to-physical mapping for the address and transmits the translation back to the GPU(s) 1108. As such, unified memory technology may allow a single unified virtual address space for memory of both the CPU(s) 1106 and the GPU(s) 1108, thereby simplifying the GPU(s) 1108 programming and porting of applications to the GPU(s) 1108.

The SoC(s) 1104 may include any number of cache(s) 1112, including those described herein. For example, the cache(s) 1112 may include L0 caches, L1 caches, L2 caches, L3 caches (e.g., that are available to both the CPU(s) 1106 and the GPU(s) 1108 (e.g., that is connected both the CPU(s) 1106 and the GPU(s) 1108)), etc. The cache(s) 1112 may include a write-back cache that may keep track of states of lines, such as by using one or more cache coherence protocol (e.g., MEI, MESI, MSI, etc.). The (e.g., L3) cache may include 4 MB or more, depending on the embodiment, although smaller or larger cache sizes may be used.

The SoC(s) 1104 may include one or more arithmetic logic units (ALUs) 1165 which may be leveraged in performing processing with respect to any of the variety of tasks or operations of the machine 1100—such as computer vision, machine learning or deep learning processing, world model management, etc. In addition, the SoC(s) 1104 may include a floating point unit(s) (FPU(s)) 1167—or other math coprocessor or numeric coprocessor types—for performing mathematical operations within the system. For example, the SoC(s) 104 may include one or more FPUs 1167 integrated as execution units within a CPU(s) 1106 and/or GPU(s) 1108.

The SoC(s) 1104 may include one or more accelerators 1114 (e.g., hardware accelerators, software accelerators, or a combination thereof). For example, the SoC(s) 1104 may include a hardware acceleration cluster that may include optimized hardware accelerators and/or large on-chip memory. The large on-chip memory 1115 (e.g., 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes), may enable the hardware acceleration cluster to accelerate neural network processing, transformer processing, optical flow processing, vision processing, and/or other calculations or processing. The hardware acceleration cluster may be used to complement the GPU(s) 1108 and to off-load some of the tasks of the GPU(s) 1108 (e.g., to free up more cycles of the GPU(s) 1108 for performing other tasks). As an example, the accelerator(s) 1114 may be used for targeted workloads (e.g., perception, convolutional neural networks (CNNs), deep neural networks (DNNs), language models (LLMs, VLMs, MMLMs, VLAs, etc.), transformer models, diffusion models, encoder-only models, encoder-decoder models, etc. that are stable enough to be amenable to acceleration.

The accelerator(s) 1114 (e.g., the hardware acceleration cluster) may include a deep learning accelerator(s) (DLA) 1109 (alternatively referred to herein as “a deep learning accelerator cluster (XNN) 1109,” “neural network accelerator (NNA) 1109,” or “neural processing unit (NPU) 1109”). The DLA(s) 1109 may include one or more Tensor processing units (TPUs) 1141 that may be configured to provide an additional, e.g., ten trillion operations per second for deep learning applications and inferencing. The TPUs 1141 may be accelerators configured to, and optimized for, performing image processing functions (e.g., for CNNs, RCNNs, DNNs, etc.). The DLA(s) 1109 may further be optimized for a specific set of neural network types and floating point operations, as well as inferencing. The design of the DLA(s) may provide more performance per millimeter than a general-purpose GPU, and vastly exceeds the performance of a CPU. The TPU(s) 1141 may perform several functions, including a single-instance convolution function, supporting, for example, INT8, INT16, and FP16 data types for both features and weights, as well as post-processor functions. Although the TPU(s) 1141 are described as being included as part of the DLA(s) 1109, this is not intended to be limiting, and the TPU(s) 1141 may be included in additional or alternative accelerator(s) 1114 and/or other components, and/or may be included as a discrete processing component(s).

The DLA(s) 1109 may quickly and efficiently execute neural networks on processed or unprocessed data for any of a variety of functions, including, for example and without limitation: for object and feature identification and detection (e.g., vehicles, pedestrians, other robots, lane lines, road boundary lines, debris, potholes, boxes, warehouse items, etc.) using data from one or more sensor modalities; for distance estimation using data from one or more sensor modalities; for emergency vehicle detection and identification and detection using data from microphones and/or vision-based sensors; for facial recognition; for pick and place operations; for manipulation operations; for occupant monitoring; for vehicle owner identification; and/or other in-cabin operations using data from in-cabin cameras and/or other sensor types; and/or a for security and/or safety related events, to name a few.

The DLA(s) 1109 may perform any function of the GPU(s) 1108, and by using an inference accelerator, for example, a designer may target either the DLA(s) 1109 or the GPU(s) 1108 for any function. For example, the designer may focus processing of DNNs and floating point operations on the DLA(s) 1109 and leave other functions to the GPU(s) 1108 and/or other accelerator(s) 1114. The DLA(s) 1109 may be used to run any type of network to enhance control and safety, including for example, a neural network that outputs a measure of confidence for each object detection.

The accelerator(s) 1114 (e.g., the hardware acceleration cluster) may include a programmable vision accelerator(s) (PVA) 1107, which may alternatively be referred to herein as a computer vision accelerator or generally a vision accelerator. The PVA(s) 1107 may be designed and configured to accelerate computer vision algorithms for the advanced driver assistance systems (ADAS), semi-autonomous driving, autonomous driving, robotics applications, security and surveillance applications, augmented reality (AR), virtual reality (VR), and/or mixed reality (MR) applications, etc. The PVA(s) 1107 may provide a balance between performance and flexibility. For example, each PVA(s) 1107 may include, for example and without limitation, any number of reduced instruction set computer (RISC) cores, direct memory access (DMA) systems, pixel processing engines (PPEs), vector processors or vector processing units (VPUs), and/or other components. The PVA engine may include an advanced very long instruction word (VLIW), single instruction multiple data (SIMD) digital signal processor. The PVA(s) 1107 may be optimized for the tasks of image processing and computer vision algorithm acceleration. For example, the PVA(s) 1107 provides excellent performance with extremely low power consumption, and can be used asynchronously and concurrently with the CPU(s) 1106, GPU(s) 1108, and/or other accelerators in the system (e.g., vehicle, robot, etc.) as part of a heterogeneous compute pipeline.

The PVA(s) 1107 may include one or more (e.g., two) vector processing subsystems (VPS), where each VPS may include one or more vector processing unit (VPU) cores, one or more decoupled look-up units (DLUTs), one or more shared or vector memories (VMEMs), and one or more instruction caches (I-caches). The VPU core(s) may be the main processing unit, and may include a vector SIMD VLIW DSP 1143 optimized for computer vision. The VPU core(s) may fetch instructions through the I-cache(s), and may access data through the VMEM(s). The DLUT(s) may include a specialized hardware component that enhances the efficiency of parallel lookup operations. For example, the DLUT(s) allow parallel lookups using a single copy of the lookup table by executing these lookups in a decoupled pipeline, independent of the primary processor pipeline. By doing so, the DLUT(s) minimize or reduce memory usage and enhance throughput while avoiding data-dependent memory bank conflicts-ultimately leading to improved overall system performance. The VPU VMEM(s) may provide local data storage for the VPU, allowing efficient implementation of various image processing and computer vision algorithms. The VPU VMEM(s) may support access from outside-VPS hosts such as direct memory access (DMA) and the CPU(s) 1106 (e.g., ARM Cortex-R5 processor), facilitating data exchange with the CPU(s) 1106 and other system-level components. The VPU I-cache may supply instruction data to the VPU(s) when requested, may request missing instruction data from system memory, and/or may maintain temporary instruction storage for the VPU. For each VPU task, the CPU(s) 1106 may configures the DMA system, optionally prefetch the VPU program into VPU I-cache, and/or kick off each VPU-DMA pair to process a task. The PVA(s) 1107 may also include an L2 SRAM memory to be shared between the one or more (e.g., two) sets of VPS and DMA. In some embodiments, one or more (e.g., two) DMA devices are used to move data among external memory, PVA L2 memory, the VMEMs (e.g., one in each VPS), CPU(s) tightly coupled memory (TCM), DMA descriptor memory, and/or PVA-level config registers. In a lightly loaded system, two parallel DMA accesses to DRAM can achieve a read/write bandwidth of up to 15 GB/s each and, in a heavily loaded system, this bandwidth can reach up to 10 GB/s each. With respect to compute compacity, the INT8 Giga Multiply-Accumulate Operations per Second (GMACs) may be 2048 or greater, excluding the DLUT. The FP32 GMACs may include 32 per PVA instance.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA system may enable components of the PVA(s) 1107 to access the system memory independently of the CPU(s) 1106. The DMA may support any number of features used to provide optimization to the PVA(s) 1107 including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors or VPUs may be programmable processors that may be designed to efficiently and flexibly execute programming for computer vision algorithms and provide signal processing capabilities. In some examples, the PVA(s) 1107 may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA(s) 1107, and may include one or more vector processing units (VPUs), one or more pixel processing engines (PPEs)—which may include a 2D layout of interconnected (e.g., for north, south, east, west intercommunication) processing elements, one or more instruction caches, and/or one or more shared or vector memories (e.g., VMEMs). A VPU core may include a digital signal processor such as, for example, a single instruction, multiple data (SIMD), very long instruction word (VLIW) digital signal processor. The combination of the SIMD and VLIW may enhance throughput and speed.

In some embodiments, each of the vector processors may include an instruction cache and may be coupled to dedicated memory. As a result, in some examples, each of the vector processors may be configured to execute independently of the other vector processors. In other examples, the vector processors that are included in a particular PVA(s) 1107 may be configured to employ data parallelism. For example, in some embodiments, the plurality of vector processors included in a single PVA(s) 1107 may execute the same computer vision algorithm, but on different regions of an image. In other examples, the vector processors included in a particular PVA(s) 1107 may simultaneously execute different computer vision algorithms, on the same image, or even execute different algorithms on sequential images or portions of an image. Among other things, any number of PVAs 1107 may be included in the hardware acceleration cluster and any number of vector processors may be included in each of the PVAs. In addition, the PVA(s) 1107 may include additional error correcting code (ECC) memory, to enhance overall system safety.

The accelerator(s) 1114 (e.g., the hardware accelerator cluster) have a wide array of uses for autonomous and semi-autonomous machine control. The PVA(s) 1107 may be a programmable vision accelerator that may be used for key processing stages in perception, robotics understanding and reasoning, ADAS, semi-autonomous, and autonomous vehicles, etc. The PVA's 1107 capabilities are a good match for algorithmic domains needing predictable processing, at low power and low latency. In other words, the PVA(s) 1107 performs well on semi-dense or dense regular computation, even on small data sets, which need predictable run-times with low latency and low power. Thus, in the context of platforms for autonomous vehicles and robotics, the PVAs 1107 are designed to run classic computer vision algorithms, as they are efficient at object detection and operating on integer math.

For example, according to one embodiment of the technology, the PVA 1107 is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA(s) 1107 may perform computer stereo vision function on inputs from two monocular cameras.

In some examples, the PVA(s) 1107 may be used to perform dense optical flow. According to process raw RADAR data (e.g., using a 4D Fast Fourier Transform) to provide Processed RADAR. In other examples, the PVA(s) 1107 is used for time-of-flight depth processing, by processing raw time of flight data to provide processed time of flight data, for example.

Although the VPU(s), DMA(s), RISC Core(s), VMEM(s), and decoupled co-processors (e.g., the DLUT(s)) are described as being included within the PVA(s) 1107, this is not intended to be limiting. In some embodiments, these components may be included in alternative or additional processing components and/or accelerator(s) 1114, and/or may be included as discrete components of the SoC(s) 1104 and/or other computing system architecture(s).

In some examples, the SoC(s) 1104 may include a real-time ray-tracing hardware accelerator (RTA) 1151 that may be used to quickly and efficiently determine the positions and extents of objects (e.g., within a world model), to generate real-time or near-real time visualization simulations, for RADAR signal interpretation, for sound propagation synthesis and/or analysis, for simulation of SONAR, RADAR, LiDAR, camera, and/or other sensor modalities within a simulation, for general wave propagation simulation, for comparison to LiDAR data for purposes of localization, to generate realistic training data for training neural networks, and/or other functions and uses. In some embodiments, one or more tree traversal units (TTUs) may be used for executing one or more ray-tracing related operations. For example, the machine 1100 (or another machine or device) may be simulated within a simulation environment, and the simulation environment may be generated using one or more light transport simulation algorithms (e.g., ray-tracing, path-tracing, etc.). These ray-tracing algorithms may thus be accelerated using a ray-tracing accelerator 1151 and/or a ray-tracing optimized GPU 1106—such as NVIDIA's RTX GPU.

The accelerator(s) 1114 (e.g., in the hardware acceleration cluster) may include one or more optical flow accelerators (OFAs) 1111. For example, the OFA(s) 1111 may be used for computing optical flow and stereo disparity between frames of sensor data (e.g., images). Optical flow may be accelerated on the OFA(s) 1111 for uses such as object detection and tracking, and/or for stereo depth estimation where used for computing stereo disparity between stereo image frames (e.g., two or more frames captured using two or more image sensors with at least partially overlapping fields of view).

The SoC(s) 1104 may include one or more camera serial interfaces (CSIs) 1123. For example, the CSI(s) 1123 may include a mobile industry processor interface (MIPI) camera serial interface (CSI) for receiving video and input from cameras, a high-speed interface, and/or a video input block that may be used for camera and related pixel input functions. The SoC(s) 1104 may further include an input/output controller(s) that may be controlled by software and may be used for receiving I/O signals that are uncommitted to a specific role. For example, the CSI 1123 may include a MIPI CSI-2 connector—e.g., a 16 lane MIPI CSI-2 connector, D-PHY 2.1 (up to 40 Gbps), and C-PHY 2.0 (up to 164 Gbps) for supporting 16 virtual channels and six or more cameras, an 8 lane MIPI CSI-2 connector, D-PHY 2.1 (up to 20 Gbps for supporting 8 virtual channels and 4 or more cameras, and/or a 2× MIPI CSI-2, 22 pin camera connector, depending on the embodiment and implementation.

The accelerator(s) 1114 (e.g., the hardware acceleration cluster) may include a computer vision network on-chip (CVNOC) 1163 and SRAM, for providing a high-bandwidth, low latency SRAM for the accelerator(s) 1114. In some examples, the on-chip memory may include at least 4 MB SRAM, consisting of, for example and without limitation, eight field-configurable memory blocks, that may be accessible by the PVA 1107, OFA 1111, DLA 1109, and/or other accelerator(s) 1114. Each pair of memory blocks may include an advanced peripheral bus (APB) interface, configuration circuitry, a controller, and a multiplexer. Any type of memory 1115 may be used. The PVA 1107, OFA 1111, DLA 1109, and/or other accelerator(s) 1114 may access the memory via a backbone that provides the accelerator(s) 1114 with high-speed access to memory. The backbone may include a computer vision network on-chip that interconnects the accelerator(s) 1114 to the memory (e.g., using the APB).

The CVNOC 1163 may include an interface that determines, before transmission of any control signal/address/data, that the accelerator(s) 1114 provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

The SoC(s) 1104 may include data store(s) 1116 and/or memory 1115. The data store(s) 1116 may be on-chip memory 1115 of the SoC(s) 1104, which may store neural networks and/or other algorithms to be executed on the CPU(s) 1106, the GPU(s) 1108, and/or one or more of the accelerator(s) 1114. In some examples, the data store(s) 1116 may be large enough in capacity to store multiple instances of neural networks for redundancy and safety. The data store(s) 1112 may comprise L2 and/or L3 cache(s) 1112, for example. The memory(ies) 1115 may include SRAM, LPDDR5, and/or other memory types. For example, the memory(ies) 1115 may include 4 MB of SRAM, 32 GB and/or 64 GB 256-bit LPDDR5 at 204.8 GB/s, 8 GB and/or 16 GB 128-bit LPDDR5 at 102.4 GB/s, and/or other memory types and sizes. Reference to the data store(s) 1116 may include reference to the memory associated with the PVA 1107, OFA 1111, DLA 1109, and/or other accelerator(s) 1114, as described herein.

The data store(s) 1116 may include various storage types, such as eMMC, NVMe, etc. For example, the SoC(s) 1104 may include storage in the form of an embedded multimedia card (eMMC) (e.g., 64 GB eMMC 5.1) and/or an SD card slot, with external NVM express (NVMe) capability, e.g., via M.2 Key M. For example, the data store(s) 1116 and/or other storage may be accessed via, e.g., NVMe, using PCI Express (PCIe), RDMA, TCP, and/or other protocols.

The SoC(s) 1104 may include one or more processor(s) 1110 (e.g., embedded processors). The processor(s) 1110 may include a boot and power management processor (BPMP) 1153, that may be a dedicated processor and subsystem to handle boot power and management functions and related security enforcement. The BPMP 1153 may be a part of the SoC(s) 1104 boot sequence and may provide runtime power management services. The BPMP 1153 may provide clock and voltage programming, assistance in system low power state transitions, management of SoC(s) 1104 thermals and temperature sensors, and/or management of the SoC(s) 1104 power states. Each temperature sensor may be implemented as a ring-oscillator whose output frequency is proportional to temperature, and the SoC(s) 1104 may use the ring-oscillators to detect temperatures of the CPU(s) 1106, GPU(s) 1108, accelerator(s) 1114, and/or other components. If temperatures are determined to exceed a threshold, BPMP 1153 may enter a temperature fault routine and put the SoC(s) 1104 into a lower power state and/or put the machine 1100 into a chauffeur to safe stop mode (e.g., bring the machine 1100 to a safe stop).

The processor(s) 1110 may further include a set of embedded processors that may serve as an audio processing engine (APE) 1155. The APE 1155 may be an audio subsystem that enables full hardware support for multi-channel audio over multiple interfaces, and a broad and flexible range of audio I/O interfaces. In some examples, the APE 1155 is a dedicated processor core with a digital signal processor with dedicated RAM.

The processor(s) 1110 may further include an always on processor engine (AOPE) 1157 that may provide necessary hardware features to support low power sensor management and wake use cases. The AOPE 1157 may include a processor core, a tightly coupled RAM, supporting peripherals (e.g., timers and interrupt controllers), various I/O controller peripherals, and routing logic.

The processor(s) 1110 may further include a safety processor(s) 1113 (alternatively referred to as “safety island 1113”), which may include a safety cluster engine that includes a dedicated processor or processor subsystem to handle safety management for automotive, robotics, and/or other applications. The safety processor(s) 1113—and/or safety cluster engine—may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations. In some embodiments, the safety processor(s) 1113 may include a discrete processor(s), such that fault of other system components may not impact the performance and availability of the safety processor 1113.

The processor(s) 1110 may further include a real-time or near real-time sensor engine (SE) 1159 that may include a dedicated processor subsystem for handling real-time or near real-time camera, LiDAR, RADAR, and/or other sensor modality management.

The processor(s) 1110 may further include one or more image signal processors (ISPs) 1127, which may include a high-dynamic range signal processor and/or a hardware engine that is part of one or more sensor processing pipelines.

The processor(s) 1110 may include a video image compositor (VIC) 1161 that may be a processing block (e.g., implemented on a microprocessor) that implements video post-processing functions needed by a video playback application to produce the final image for the player window. The VIC 1161 may perform lens distortion correction on wide-view camera(s) 1168B, surround camera(s) 1168D, in-cabin monitoring camera sensors, and/or other camera sensors with distorted fields of view.

A VIC 1161 may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

A VIC 1161 may also be configured to perform stereo rectification on input stereo lens frames. The video image compositor may further be used for user interface composition when the operating system desktop is in use, and the GPU(s) 1108 is not required to continuously render new surfaces. Even when the GPU(s) 1108 is powered on and active doing 3D rendering, the video image compositor may be used to offload the GPU(s) 1108 to improve performance and responsiveness.

The SoC(s) 1104 may further include a broad range of peripheral interfaces for input/output (I/O) 1125, such as to enable communication with peripherals, audio codecs, power management, and/or other devices. The SoC(s) 1104 may be used to process data from cameras (e.g., connected over Gigabit Multimedia Serial Link and/or Ethernet), sensors (e.g., LiDAR sensor(s) 1164, RADAR sensor(s) 1160, etc. that may be connected over Ethernet), data from bus 1102 (e.g., speed of machine 1100, steering wheel position, etc.), data from GNSS sensor(s) 1158 (e.g., connected over Ethernet or CAN bus). The SoC(s) 1104 may further include dedicated high-performance mass storage controllers that may include their own DMA engines, and that may be used to free the CPU(s) 1106 from routine data management tasks. In some embodiments, the SoC(s) 1104 I/O 1125 may include a header (e.g., a 40 pin header, or 40 pin expansion header) with support for universal asynchronous receiver/transmitter (UART), serial peripheral interface (SPI), inter-integrated circuit sound (I2S), inter-integrated circuit (I2C), controller area network (CAN), pulse width modulation (PWM), digital microphone interface (DMIC), digital speaker station (DSPK), general purpose I/O (GPIO), etc., an automation header (e.g., 12 pin automation header), an audio panel header (e.g., a 10 pin audio panel header), a joint test action group (JTAG) header (e.g., a 10 pin JTAG header), a fan header (e.g., a 4 pin fan header), an RTC battery backup connector (e.g., a 2 pin battery backup connector), a microSD slot, a DC power jack, power, force, recovery, and reset buttons, one or more display connectors (e.g., DisplayPort (DP), such as a DP 1.4A (+MST), an eDP 1.41, an HDMI 2.1, and/or a 4K30 multi-model DP 1.2 (+MST) connector), and/or other I/O 1125 elements, components, or features.

The SoC(s) 1104 may include in-machine networking capability using, for example, Ethernet (e.g., automotive Ethernet), SERDES, controller area network (CAN), FlexRay, local interconnect network (LIN), low voltage differential signaling (LVDS), media oriented system transport (MOST), another networking type, and/or a combination thereof. For example, the SoC(s) 1104 may include an RJ45 connector with up to 10 GbE, a 1 GbE connector, and/or other networking connector types.

The SoC(s) 104 may include one or more digital signal processors (DSPs) 1143. For example, the DSP(s) 1143 may include a dedicated or specialized microprocessor chip optimized for digital signal processing—such as in audio signal processing, telecommunications, digital image processing, RADAR, SONAR, LiDAR, and/or other sensor processing, speech recognition, and/or other applications.

The SoC(s) 1104 may include one or more video encoders 1119 and/or one or more video decoders 1121. For example, the video encoder(s) 1119 may include a hardware-based (e.g., as part of the GPU(s) 1108) video encoder (e.g., supporting H.264, H.265, etc., and being HEVC compliant, such as NVIDIA's NVENC) that may process image inputs (e.g., as YUV, RGB, etc.) to generate a video bit stream. The video decoder(s) 1121 may include a video decoder engine that may provide fully-accelerated hardware video decoding capabilities (e.g., supporting decoding of bitstreams in various formats, such as AV1, H.264, H.265, VP8, VP9, MPEG-1, MPEG-2, MPEG-4, VC-1, etc, and being HEVC compliant, such as NVIDIA's NVDEC). In some examples, the video decoder(s) 1121 may be hardware-based (e.g., as part of the GPU(s) 1108).

The SoC(s) 1104 may include one or more general compute acceleration clusters (GCAC(s)) 1129. For example, the GCAC(s) 1129 may include various processor types that may be used to accelerate compute, such as one or more vector microcode processors (VMPs) 1133, one or more multi-threaded processing clusters (MPCs) 1131, one or more programmable macro arrays (PMA(s)) 1135, and/or one or more other processor types. For example, the GCAC(s) 1129 may include a PMA 1135, two VMPs 1133, and 2 MPCs 1131.

The SoC(s) 1104 may include one or more vector microcode processors (VMPs) 1133. The VMP(s) 1133, in embodiments, may include a wide vector (very long instruction word (VLIW) and single instruction multiple data (SIMD)) machine with performing various operations, such as short integral type operations common in computer vision and deep learning algorithms.

The SoC(s) 1104 may include one or more multi-threaded processing clusters (MPCs) 1131. The MPC(s) 1131 may include a processing cluster that be, in embodiments, more versatile than a GPU, and with higher efficiency than a CPU. For example, the MPC(s) 1131 may include a multi-threaded processor that allows multiple threads to share resources and execute instructions concurrently.

The SoC(s) 1104 may include one or more programmable macro arrays (PMA(s)) 1135. The PMA(s) 1135 may include a coarse-grained reconfigurable architecture (CGRA) dataflow machine, having a unique architecture that delivers strong performance on dense computer vision and deep learning algorithms that may be unachievable in classic digital signal processing (DSP) architectures.

The SoC(s) 1104 may include one or more display processing units (DPUs) 1145 for performing hardware-accelerated image processing. For example, the DPU(s) 1145 may retrieve pixel data from memory 1115 and send it to a display peripheral through standard interfaces. As such, the DPU(s) 1145 may handle display processing and rendering for in-machine and/or on-machine displays.

The SoC(s) 1104 may include one or more application processing units (APUs) 1139. For example, the APU(s) 1139 may include a quad or dual-core processor with 48 KB/32 KB L1 cache with parity and ECC, along with a 1 MB L2 cache with ECC. The APU(s) 1139 may support NEON instructions and single and double precision floating point operations.

The SoC(s) 1104 may include one or more real-time processing units (RTPUs) 1169. The RTPU(s) 1169 may include a dual-core processor with 32 KB/32 KB L1 cache, and 256 KB TCM with ECC. The RTPU(s) 1169 may support single and double precision floating point operations.

The SoC(s) 1104 may include one or more built-in self-test (BIST) components 1137. For example, the BIST component(s) 1137 may include memory BIST (MBIST) to test memories of the system and/or logic BIST (LBIST) to test logic of the system. The BIST components 1137 may include embedded logic for directly testing logic and/or memory of the system.

The SoC(s) 1104 may include one or more dynamically reconfigurable processors (DRPs) 1171. For example, the DRP(s) 1171 may be used for accelerating various computing operations. For example, the DRP(s) 1171 may be combined, in embodiments, with a MAC unit for use as an AI accelerator. In embodiments, the DRP(s) 1171 may execute applications while dynamically switching the circuit connection configuration of the arithmetic units (e.g., ALUs) on the chip at each operating clock according to the content to be processed. Since only the necessary arithmetic circuits are used, the DRP(s) 1171 may consume less power than with CPU processing and can achieve higher speed. Furthermore, compared to CPUs, where frequent external memory accesses due to cache misses and other causes will degrade performance, the DRP(s) 1171 can build the necessary data paths in hardware ahead of time, resulting in less performance degradation and less variation in operating speed (jitter) due to memory accesses. The DRP(s) 1171 may include a dynamic loading function that switches the circuit connection information each time the algorithm changes, enabling processing with limited hardware resources, even in robotic/automotive applications that require processing of multiple algorithms.

In some embodiments, the accelerator(s) 1114 may include an OpenCV accelerator for speeding up processing of OpenCV, an open-source industry standard library for computer vision processing. In some embodiments, the combination of one or more DRP(s) 1171 deployed as an AI accelerator along with an OpenCV accelerator(s) may enhance AI computing and image processing algorithms, enabling complex and compute-heavy operations such as Visual simultaneous localization and mapping (SLAM).

In contrast to conventional systems, by providing a CPU complex, GPU complex, and a hardware acceleration cluster, the technology described herein allows for multiple neural networks to be performed simultaneously (e.g., at least partially in parallel) and/or sequentially, and for the results to be combined together to enable Level 2-5 autonomous driving functionality and/or autonomous robotics movement, control, planning, and/or navigation operations. In addition, because the SoC(s) 1104 may include various compute engines (e.g., processors 1110, CPUs 1106, GPU(s) 1108, accelerator(s) 1114, etc.), tasks may be distributed between and among the compute engines, in some instances without common cause failures due to the discrete footprint of the compute engines. Further, because the SoC(s) 1104 may include a dedicated safety processor(s) 1113 (or safety island 1113), critical safety or redundant operations may be performed without common cause failures from the main processing components or compute engines of the SoC(s) 1114. Due to these features, the SoC(s) 1104 and/or the underlying systems of the machine 1100 may be capable of satisfying higher levels of safety—such as automotive safety integrity level (ASIL) D from the ISO 26262 standard.

FIG. 11E is a system diagram for communication between a cloud-based server(s) (e.g., in a data center, such as those described herein) and the example autonomous or semi-autonomous vehicle or machine 1100 of FIG. 11A, in accordance with some embodiments of the present disclosure. The system 1176 may include a server(s) 1178, a network(s) 1190, and a machine(s) 1100. The server(s) 1178 may include a plurality of GPUs 1184(A)-1184(H) (collectively referred to herein as GPUs 1184), switches 1182(A)-1182(H) (such as PCIe 4.0/5.0/etc switches, M.2 slots, thunderbolt, USB4, NVIDIA's NVLink, NVIDIA's NVSwitch, GPUDirect RDMA, GPUDirect Storage, etc.), CPUs 1180(A)-1180(B) (collectively referred to herein as CPUs 1180), accelerators, and/or other processor types. The GPUs 1184, the CPUs 1180, and the PCIe switches may be interconnected with high-speed interconnects such as, for example and without limitation, NVLink interfaces 1188 developed by NVIDIA and/or PCIe connections 1186. In some examples, the GPUs 1184 are connected via NVLink and/or NVSwitch SoC and the GPUs 1184 and the PCIe switches 1182 are connected via PCIe interconnects. Although eight GPUs 1184, two CPUs 1180, and two PCIe switches are illustrated, this is not intended to be limiting. Depending on the embodiment, each of the server(s) 1178 may include any number of GPUs 1184, CPUs 1180, and/or PCIe switches. For example, the server(s) 1178 may each include eight, sixteen, thirty-two, and/or more GPUs 1184.

The server(s) 1178 may receive, over the network(s) 1190 and from the machine(s) 1100, sensor data indicating information about new or previously unexplored locations, and/or sensor data indicating changes to previously seen/stored locations (e.g., unexpected or changed road conditions, such as recently commenced road-work). The server(s) 1178 may transmit, over the network(s) 1190 and to the machine(s) 1100, neural networks 1192, updated neural networks 1192, map information 1194, etc., including information regarding traffic and road conditions. The updates to the map information 1194 may include updates for the HD map 1122, SD map, navigation map, etc., such as information regarding construction sites, potholes, detours, flooding, and/or other obstructions. In some examples, the neural networks 1192, the updated neural networks 1192, the map information 1194, and/or the other information may have resulted from new training and/or experiences represented in data received from any number of machine(s) 1100 in the environment, and/or based on training performed at a datacenter (e.g., using the server(s) 1178 and/or other servers).

The server(s) 1178 may be used to train machine learning models (e.g., neural networks) based on training data. The training data may be generated by the machine(s) 1100, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the machine(s) 1100 (e.g., transmitted to the machine(s) 1100 over the network(s) 1190, and/or the machine learning models may be used by the server(s) 1178 to remotely monitor and/or control the machine(s) 1100.

In some examples, the server(s) 1178 may receive data from the machine(s) 1100 and apply the data to up-to-date real-time neural networks for real-time intelligent inferencing. The server(s) 1178 may include deep-learning supercomputers and/or dedicated AI computers powered by GPU(s) 1184, such as a DGX and DGX Station machines developed by NVIDIA. However, in some examples, the server(s) 1178 may include deep learning infrastructure that use only CPU-powered datacenters.

The deep-learning infrastructure of the server(s) 1178 may be capable of fast, real-time inferencing, and may use that capability to evaluate and verify the health of the processors, software, and/or associated hardware in the machine 1100. For example, the deep-learning infrastructure may receive periodic updates from the machine 1100, such as a sequence of images and/or objects that the machine 1100 has located in that sequence of images (e.g., via computer vision and/or other machine learning object classification techniques). The deep-learning infrastructure may run its own neural network to identify the objects and compare them with the objects identified by the machine 1100 and, if the results do not match and the infrastructure concludes that the AI in the machine 1100 is malfunctioning, the server(s) 1178 may transmit a signal to the machine 1100 instructing a fail-safe computer of the machine 1100 to assume control, notify the passengers, and complete a safety maneuver or operation—such as to slow down, hand control back to a driver, come to a stop, and/or pull over/shut down.

For inferencing, the server(s) 1178 may include the GPU(s) 1184 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Computing Ecosystem for Generating, Training, and Deploying AI

FIG. 12 is a system diagram illustrating a three computer ecosystem 1200, including a first computing system 1202 for generating or creating artificial intelligence (AI)—such as AI training and validation data, a second computing system 1204 for training artificial intelligence, and a third computing system 1206 (which may include or correspond to the SoC(s) 1104 of FIGS. 11A-11E) deploying the AI at the edge, in accordance with at least some embodiments of the present disclosure. For example, to develop and deploy embodied or physical AI, the three computer ecosystem 1200 may be used, including three accelerated computer systems to handle physical AI training, simulation, and runtime (e.g., edge deployment). These systems may generate training data for and train multimodal foundation models (and/or other model types) using scalable, physically based simulations of the machine(s) 1100 and their worlds. By doing so, simulation of machine(s) 1100 may be performed at scale, allowing for refinement, testing, and optimization of skills (e.g., robot skills) in a virtual world (e.g., using NVIDIA's OMNIVERSE) that mimics the laws of physics-helping to reduce real-world data acquisition costs and ensuring the machine(s) 1100 can perform safely in controlled settings.

The computing system 1204 (e.g., NVIDIA's DGX Platform) may be used to train and fine-tune powerful foundation and generative AI models. Models, such as general purpose foundation models (e.g., NVIDIA's Project GR00T), may be used to enable robots and other machine(s) 1100 to understand natural language and emulate movements by observing human actions. The computing system 1204 may include a platform that incorporates software, infrastructure, and expertise in a modern, unified AI development and training solution. The computing system 1204 may include individual computing devices 1210 (e.g., NVIDIA's DGX B200, H200, etc.) and/or any number of computing devices 1210 in a data center infrastructure 1212 (e.g., NVIDIA's DGX SuperPOD).

For example, the individual computing devices 1210 may include GPUs (e.g., 8 GPUs with 1,440 GB total GPU memory) and CPUs (e.g., 2 CPUs with 112 cores total, 2.1 GHz, or 4 GHz (with boost)) that provide upwards of 72 petaFLOPS for training and 144 petaFLOPS for inference. The computing devices 1210 may include memory (e.g., 4 TB memory, and storage (e.g., OS storage of 2×1.9 TB NVMe M.2, and internal storage of 8×3.84 TB NVMe U.2). The computing devices 1210 may include various networking and network management components, such as OSFP ports (e.g., 4 OSFP ports) serving single-port smart host channel adapters (e.g., 8 single port ConnextX-7 virtual protocol interconnects (VPIs)), providing up to 400 GB/s Infiniband/Ethernet. The computing devices 1210 may further include, e.g., dual port quad small form-factor pluggable (QSFFP) data processing units (DPUs) (e.g., 2 dual-port QSFP112 DPUs—such as NVIDIA's BlueField-3 DPUs), providing up to 400 Gb/s InfiniBand/Ethernet. The computing device(s) 1210 may include an onboard network interface card (NIC) (e.g., 10 Gb/s onboard NIC with RJ45), a dual-port Ethernet NIC (e.g., 100 GB/s dual-port Ethernet NIC), and/or a host baseboard management controller (MBC) (e.g., with RJ45). In some embodiments, the NICs used for the computing device(s) 1210 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1210 may include a smart host channel adapter (HCA) (e.g., NVIDIA's ConnectX-7) to provide ultra-low latency, 400 Gb/s throughput for in-network computing acceleration engines.

The data center infrastructure 1212 may include any number of the computing devices 1210, along with an operating system (OS) (e.g., DGX OS extensions for Linux distributions) to maximize system uptime, security, and reliability, network/storage acceleration libraries and management to accelerate end-to-end infrastructure performance, cluster management to scale and manage one node (e.g., one computing device 1210) to thousands, job scheduling and orchestration to ensure hassle-free execution of every developer's job, AI workflow management and machine learning operations (MLOps) to move more models from prototype to production, and enterprise software to speed developer success.

The computing system 1202 (e.g., NVIDIA's OVX servers) may provide a development and simulation platform for testing and optimizing physical AI with APIs and frameworks for simulation (e.g., NVIDIA's DriveSIM, ISAAC Sim, ISAAC Gym, ISAAC Labetc.). The computing system 1202 allows developers to use simulation frameworks to simulate and validate robot models, and/or to generate massive amounts of physically-based synthetic data to bootstrap model training. The computing system 1202 may support learning frameworks that power robot reinforcement learning and imitation learning, to accelerate robot policy training and refinement. For example, the computing system 1202 may be used to generate any number of simulations 1208-such as within NVIDIA's OMNIVERSE. The computing system 1202 may be used optimized for accelerating an entire software stack, from training, fine-tuning, and deploying generative AI to powering industrial digitalization within a content collaboration platform of APIs, software developer kits (SDKs), and services that allow for integration of OpenUSD, ray-tracing rendering technologies (e.g., NVIDIA's RTX), and generative physical AI into existing software tools and simulation workflows for, e.g., industrial and robotics use cases (e.g., NVIDIA's OMNIVERSE). As such, the computing system 1202 may host or support a native OpenUSD software platform enabling enterprises to connect 3D pipelines and develop advanced, real-time 3D applications for industrial digitalization. With powerful ray-tracing-accelerated AI and graphics capabilities, the computing system 1202 delivers powerful performance for workloads like extended reality (XR), multi-user design collaboration, and digital twins. This allows creation of physically accurate models with high-fidelity ray-traced and path-traced rendering of materials, operation of large-scale, AI-enabled simulations, and generation of photorealistic 3D synthetic data for training. The computing system 1202 may include individual computing devices 1214 (e.g., NVIDIA's OVX L40S Server) and/or any number of computing devices 1214 in a data center infrastructure 1216 (e.g., NVIDIA's OVX Systems).

The computing device(s) 1214 (which may include a server) may include CPUs (e.g., 2 CPUs with 32 cores each), and GPUs (e.g., 4 or 8 GPUs, each including 48 GB GDDR 6 with ECC memory, 864 GB/s memory bandwidth, PCIe Gen4×16: 64 GB/s bidirectional interconnect interface, 18,176 CUDA cores, 142 ray tracing (RT) cores, and 568 tensor cores). The computing devices 1214 may include various networking and network management components, such as smart host channel adapters (HCA) (e.g., 2 or 4 single port ConnextX-7 at 200 Gb/s each, providing up to 800 Gb/s Infiniband/Ethernet), one or more DPUs (e.g., a dual-port QSFP112 DPUs-such as an NVIDIA BlueField-3 DPU), providing up to 400 Gb/s InfiniBand/Ethernet. In some embodiments, the NICs used for the computing device(s) 1214 may include SuperNICs (e.g., NVIDIA's ConnectX-8 SuperNIC) to provide up to 800 Gb/s of data throughput for in-network computing acceleration engines to deliver the performance and robust feature set needed to power trillion-parameter scale AI factories and scientific computing workloads. In other embodiments, the computing device(s) 1214 may include a smart host channel adapter (HCA) (e.g., NVIDIA's ConnectX-7) to provide ultra-low latency, 400 Gb/s throughput for in-network computing acceleration engines. The computing device(s) 1214 may include a host memory (e.g., 384 Gb DDR5 ECC for 4 GPUs, or 768 Gb DDR5 ECC for 8 GPUs), and may include a dual in-line memory module (DIMM) slot(s), a host boot drive (e.g., 1 TB NVMe), and/or a host storage (e.g., 2 4 TB NVMe).

Similar to the data center infrastructure 1212, the data center infrastructure 1216 may allow for any number of computing device(s) 1214 to be combined in cluster configuration according to a reference architecture.

The computing system 1206 may be used to deploy trained AI models on a runtime computer-such as the SoC(s) 1104 described herein. For example, these computing systems 1206 may be designed for compact, on-board computing needs, including an ensemble of models for control policy, vision and language models, etc., deployed on a power-efficient on-board edge computing system 1206. Details of components, features, and capabilities of the computing system 1206 may be described in more detail herein with respect to FIGS. 11A-11E.

### Example Generative Models

In at least some embodiments, language models, such as large language models (LLMs), vision language models (VLMs), multi-modal language models (MMLMs), vision-language-action (VLA) models, and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio (sounds, synthetic speech, etc.), 2D and/or 3D data (e.g., in USD formats), and/or video. For example, vision language models (VLMs), or more generally multi-modal language models (MMLMs), may be implemented to accept image, video, sensor, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein —may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 13 is a block diagram of an example generative language model system 1300 suitable for use in implementing at least some embodiments of the present disclosure. In the example illustrated in FIG. 13, the generative language model system 1300 includes a retrieval augmented generation (RAG) component 1392, an input processor 1305, a tokenizer 1310, an embedding component 1320, plug-ins/APIs 1395, and a generative language model (LM) 1330 (which may include an LLM, a VLM, a MMLM, a VLA model, etc.).

At a high level, the input processor 1305 may receive an input 1301 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 1330 (e.g., LLM/VLM/MMLM/etc.). In some embodiments, the input 1301 includes plain text in the form of one or more sentences, paragraphs, and/or documents. Additionally or alternatively, the input 1301 may include numerical sequences, precomputed embeddings (e.g., word or sentence embeddings), and/or structured data (e.g., in tabular formats, JSON, or XML). In some implementations in which the generative LM 1330 is capable of processing multi-modal inputs, the input 1301 may combine text (or may omit text) with image data, audio data, video data, design data, USD data, and/or other types of input data, such as but not limited to those described herein. Taking raw input text as an example, the input processor 1305 may prepare raw input text in various ways. For example, the input processor 1305 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1305 may remove stopwords to reduce noise and focus the generative LM 1330 on more meaningful content. The input processor 1305 may apply text normalization (TN), for example, by converting all characters to lowercase, removing accents, and/or or handling special cases like contractions or abbreviations to ensure consistency (e.g., converting ¼ to one quarter). Similarly, the input processor 1305 and/or a post-processor may perform inverse text normalization (ITN) in order to convert plain language back to canonical or other forms (e.g., to convert one quarter to ¼). These are just a few examples, and other types of input and/or output processing may be applied.

In some embodiments, a RAG component 1392 (which may include one or more RAG models, and/or may be performed using the generative LM 1330 itself) may be used to retrieve additional information to be used as part of the input 1301 or prompt. RAG may be used to enhance the input to the LLM/VLM/MMLM/etc. with external knowledge, so that answers to specific questions or queries or requests are more relevant—such as in a case where specific knowledge is required. The RAG component 1392 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1301 may be generated using the query or input to the model (e.g., a question, a request, etc.) in addition to data retrieved using the RAG component 1392. In some embodiments, the input processor 1305 may analyze the input 1301 and communicate with the RAG component 1392 (or the RAG component 1392 may be part of the input processor 1305, in embodiments) in order to identify relevant text and/or other data to provide to the generative LM 1330 as additional context or sources of information from which to identify the response, answer, or output 1390, generally. For example, where the input indicates that the user is interested in a desired tire pressure for a particular make and model of vehicle, the RAG component 1392 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1392 may retrieve a prior stored conversation history—or at least a summary thereof—and include the prior conversation history along with the current ask/request as part of the input 1301 to the generative LM 1330.

The RAG component 1392 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1392 and the embeddings of the chunks along with the embeddings of the query may be compared to identify the most similar/related embeddings to the query, which may be supplied to the generative LM 1330 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1392 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1310 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1330 to understand morphological variations and handle out-of-vocabulary words more effectively. Character-based tokenization represents each character as a separate token, enabling the generative LM 1330 to process text at a fine-grained level. The choice of tokenization strategy may depend on factors such as the language being processed, the task at hand, and/or characteristics of the training dataset. As such, the tokenizer 1310 may convert the (e.g., processed) text into a structured format according to tokenization schema being implemented in the particular embodiment.

The embedding component 1320 may use any known embedding technique to transform discrete tokens into (e.g., dense, continuous vector) representations of semantic meaning. For example, the embedding component 1320 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1301 includes image data/video data/etc., the input processor 1301 may resize the data to a standard size compatible with format of a corresponding input channel and/or may normalize pixel values to a common range (e.g., 0 to 1) to ensure a consistent representation, and the embedding component 1320 may encode the image data using any known technique (e.g., using one or more convolutional neural networks (CNNs) to extract visual features). In some implementations in which the input 1301 includes audio data, the input processor 1301 may resample an audio file to a consistent sampling rate for uniform processing, and the embedding component 1320 may use any known technique to extract and encode audio features such as in the form of a spectrogram (e.g., a mel-spectrogram). In some implementations in which the input 1301 includes video data, the input processor 1301 may extract frames or apply resizing to extracted frames, and the embedding component 1320 may extract features such as optical flow embeddings or video embeddings and/or may encode temporal information or sequences of frames. In some implementations in which the input 1301 includes multi-modal data, the embedding component 1320 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1330 and/or other components of the generative LM system 1300 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, linear-time sequence modeling with selective state space modeling (SSM) architectures (e.g., Mamba LLM architectures), and/or others. As such, depending on the implementation and architecture, the embedding component 1320 may apply an encoded representation of the input 1301 to the generative LM 1330, and the generative LM 1330 may process the encoded representation of the input 1301 to generate an output 1390, which may include responsive text and/or other types of data.

As described herein, in some embodiments, the generative LM 1330 may be configured to access or use—or capable of accessing or using—plug-ins/APIs 1395 (which may include one or more plug-ins, application programming interfaces (APIs), databases, data stores, repositories, etc.). For example, for certain tasks or operations that the generative LM 1330 is not ideally suited for, the model may have instructions (e.g., as a result of training, and/or based on instructions in a given prompt, such as those retrieved using the RAG component 1392) to access one or more plug-ins/APIs 1395 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1395 to the plug-in/API 1395, the plug-in/API 1395 may process the information and return an answer to the generative LM 1330, and the generative LM 1330 may use the response to generate the output 1390. This process may be repeated—e.g., recursively—for any number of iterations and using any number of plug-ins/APIs 1395 until an output 1390 that addresses each ask/question/request/process/operation/etc. from the input 1301 can be generated. As such, the model(s) may not only rely on its own knowledge from training on a large dataset(s) and/or from data retrieved using the RAG component 1392, but also on the expertise or optimized nature of one or more external resources—such as the plug-ins/APIs 1395.

In some embodiments, one or more transformer engines (TEs) may be implemented. The transformer engine may use micro-tensor scaling to optimize performance and accuracy-such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as micro-scaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

These and other architectures for LLMs/VLMs/MMLMs/VLAs/etc. described herein are meant simply as examples, and other suitable architectures may be implemented within the scope of the present disclosure.

### Example Computing Device

FIG. 14 is a block diagram of an example computing device(s) 1400 suitable for use in implementing some embodiments of the present disclosure. Computing device 1400 may include an interconnect system 1402 that directly or indirectly couples the following devices: memory 1404, one or more central processing units (CPUs) 1406, one or more graphics processing units (GPUs) 1408, a communication interface 1410, input/output (I/O) ports 1412, input/output components 1414, a power supply 1416, one or more presentation components 1418 (e.g., display(s), speaker(s), etc.), and one or more logic units 1420. In at least one embodiment, the computing device(s) 1400 may comprise one or more virtual machines (VMs), and/or any of the components thereof may comprise virtual components (e.g., virtual hardware components). For non-limiting examples, one or more of the GPUs 1408 may comprise one or more vGPUs, one or more of the CPUs 1406 may comprise one or more vCPUs, and/or one or more of the logic units 1420 may comprise one or more virtual logic units. As such, a computing device(s) 1400 may include discrete components (e.g., a full GPU dedicated to the computing device 1400), virtual components (e.g., a portion of a GPU dedicated to the computing device 1400), or a combination thereof.

Although the various blocks of FIG. 14 are shown as connected via the interconnect system 1402 with lines, this is not intended to be limiting and is for clarity only. For example, in some embodiments, a presentation component 1418, such as a display device, may be considered an I/O component 1414 (e.g., if the display is a touch screen). As another example, the CPUs 1406 and/or GPUs 1408 may include memory (e.g., the memory 1404 may be representative of a storage device in addition to the memory of the GPUs 1408, the CPUs 1406, and/or other components). As such, the computing device of FIG. 14 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 14.

The interconnect system 1402 may represent one or more links or busses, such as an address bus, a data bus, a control bus, or a combination thereof. The interconnect system 1402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1406 may be directly connected to the memory 1404. Further, the CPU 1406 may be directly connected to the GPU 1408. Where there is direct, or point-to-point connection between components, the interconnect system 1402 may include a PCIe link to carry out the connection. In these examples, a PCI bus need not be included in the computing device 1400.

The memory 1404 may include any of a variety of computer-readable media. The computer-readable media may be any available media that may be accessed by the computing device 1400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1406 may be configured to execute at least some of the computer-readable instructions to control one or more components of the computing device 1400 to perform one or more of the methods and/or processes described herein. The CPU(s) 1406 may each include one or more cores (e.g., one, two, four, eight, twenty-eight, seventy-two, etc.) that are capable of handling a multitude of software threads simultaneously. The CPU(s) 1406 may include any type of processor, and may include different types of processors depending on the type of computing device 1400 implemented (e.g., processors with fewer cores for mobile devices and processors with more cores for servers). For example, depending on the type of computing device 1400, the processor may be an Advanced RISC Machines (ARM) processor implemented using Reduced Instruction Set Computing (RISC) or an x86 processor implemented using Complex Instruction Set Computing (CISC). The computing device 1400 may include one or more CPUs 1406 in addition to one or more microprocessors or supplementary co-processors, such as math co-processors.

In addition to or alternatively from the CPU(s) 1406, the GPU(s) 1408 may be configured to execute at least some of the computer-readable instructions to control one or more components of the computing device 1400 to perform one or more of the methods and/or processes described herein. One or more of the GPU(s) 1408 may be an integrated GPU (e.g., with one or more of the CPU(s) 1406 and/or one or more of the GPU(s) 1408 may be a discrete GPU. In embodiments, one or more of the GPU(s) 1408 may be a coprocessor of one or more of the CPU(s) 1406. The GPU(s) 1408 may be used by the computing device 1400 to render graphics (e.g., 3D graphics) or perform general purpose computations. For example, the GPU(s) 1408 may be used for General-Purpose computing on GPUs (GPGPU). The GPU(s) 1408 may include hundreds or thousands of cores that are capable of handling hundreds or thousands of software threads simultaneously. The GPU(s) 1408 may generate pixel data for output images in response to rendering commands (e.g., rendering commands from the CPU(s) 1406 received via a host interface). The GPU(s) 1408 may include graphics memory, such as display memory, for storing pixel data or any other suitable data, such as GPGPU data. The display memory may be included as part of the memory 1404. The GPU(s) 1408 may include two or more GPUs operating in parallel (e.g., via a link). The link may directly connect the GPUs (e.g., using NVLINK) or may connect the GPUs through a switch (e.g., using NVSwitch). When combined together, each GPU 1408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1406 and/or the GPU(s) 1408, the logic unit(s) 1420 may be configured to execute at least some of the computer-readable instructions to control one or more components of the computing device 1400 to perform one or more of the methods and/or processes described herein. In embodiments, the CPU(s) 1406, the GPU(s) 1408, and/or the logic unit(s) 1420 may discretely or jointly perform any combination of the methods, processes and/or portions thereof. One or more of the logic units 1420 may be part of and/or integrated in one or more of the CPU(s) 1406 and/or the GPU(s) 1408 and/or one or more of the logic units 1420 may be discrete components or otherwise external to the CPU(s) 1406 and/or the GPU(s) 1408. In embodiments, one or more of the logic units 1420 may be a coprocessor of one or more of the CPU(s) 1406 and/or one or more of the GPU(s) 1408.

Examples of the logic unit(s) 1420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1410 may include one or more receivers, transmitters, and/or transceivers that allow the computing device 1400 to communicate with other computing devices via an electronic communication network, included wired and/or wireless communications. The communication interface 1410 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1420 and/or communication interface 1410 may include one or more data processing units (DPUs) to transmit data received over a network and/or through interconnect system 1402 directly to (e.g., a memory of) one or more GPU(s) 1408.

The I/O ports 1412 may allow the computing device 1400 to be logically coupled to other devices including the I/O components 1414, the presentation component(s) 1418, and/or other components, some of which may be built in to (e.g., integrated in) the computing device 1400. Illustrative I/O components 1414 include a microphone, mouse, keyboard, joystick, game pad, game controller, satellite dish, scanner, printer, wireless device, etc. The I/O components 1414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1400. The computing device 1400 may be include depth cameras, such as stereoscopic camera systems, infrared camera systems, RGB camera systems, touchscreen technology, and combinations of these, for gesture detection and recognition. Additionally, the computing device 1400 may include accelerometers or gyroscopes (e.g., as part of an inertia measurement unit (IMU)) that allow detection of motion. In some examples, the output of the accelerometers or gyroscopes may be used by the computing device 1400 to render immersive augmented reality or virtual reality.

The power supply 1416 may include a hard-wired power supply, a battery power supply, or a combination thereof. The power supply 1416 may provide power to the computing device 1400 to allow the components of the computing device 1400 to operate.

The presentation component(s) 1418 may include a display (e.g., a monitor, a touch screen, a television screen, a heads-up-display (HUD), other display types, or a combination thereof), speakers, and/or other presentation components. The presentation component(s) 1418 may receive data from other components (e.g., the GPU(s) 1408, the CPU(s) 1406, DPUs, etc.), and output the data (e.g., as an image, video, sound, etc.).

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1400 of FIG. 14—e.g., each device may include similar components, features, and/or functionality of the computing device(s) 1400. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1400 described herein with respect to FIG. 14. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### EXAMPLE CLAUSES

A. A method comprising: determining, based at least on one or more failure thresholds associated with one or more safety goals of a machine, one or more quantities of test data associated with statistically validating performance of one or more systems or components of the machine with respect to the one or more safety goals; determining, based at least on information obtained from one or more operational usage models indicative of one or more anticipated driving conditions of the machine, one or more target distributions for the test data across the one or more anticipated driving conditions; obtaining, for the test data and based at least on the one or more quantities and the one or more target distributions, at least one or more sensor data recordings corresponding to one or more types of driving scenarios associated with the one or more safety goals; generating, based at least on one or more labeling specifications associated with the one or more safety goals, labeled ground truth data corresponding to the one or more sensor data recordings; and storing, as one or more test datasets, at least the one or more sensor data recordings and the labeled ground truth data.

B. The method of paragraph A, further comprising: applying, as one or more test inputs to the one or more systems or components of the machine, the one or more sensor data recordings; obtaining output data indicating one or more control operations performed by the one or more systems or components of the machine responsive to the one or more test inputs; and evaluating the performance of the one or more systems or components of the machine based at least on comparing the output data with the labeled ground truth data.

C. The method of any one of paragraphs A-B, wherein the determining of the one or more quantities of the test data is based at least on performing one or more fault-tree analyses of the one or more safety goals.

D. The method of any one of paragraphs A-C, wherein the obtaining of the one or more sensor data recordings comprises: defining, based at least on the one or more target distributions, one or more paths for one or more second machines to follow through one or more environments; and causing the one or more second machines to traverse the one or more paths, wherein one or more sensors of the one or more second machines generate at least a portion of the one or more sensor data recordings while traversing the one or more paths.

E. The method of any one of paragraphs A-D, wherein the one or more sensor data recordings correspond to one or more first geographic locations that are distinguishable from one or more second geographic locations corresponding to training data used to train the one or more systems or components of the machine.

F. The method of any one of paragraphs A-E, wherein the one or more anticipated driving conditions of the machine include at least one of: one or more countries the machine is anticipated to operate in, one or more road types the machine is anticipated to operate on, one or more weather conditions the machine is anticipated to operate in, one or more times of day the machine is anticipated to operate during, or one or more traffic densities the machine is anticipated to operate in.

G. The method of any one of paragraphs A-F, further comprising: generating, for at least a portion of the test data and based at least on the one or more target distributions, one or more simulated sensor data recordings corresponding to one or more simulated driving scenarios associated with the one or more safety goals; and storing, in the one or more test datasets, the one or more simulated sensor data recordings and corresponding ground truth data.

H. A system comprising one or more processors to: determine a quantity of test data sufficient to validate performance of one or more machines with respect to one or more safety goals; determine, based at least on anticipated driving conditions for the one or more machines, one or more target distributions of the test data across the anticipated driving conditions; obtain, based at least on the quantity and the one or more target distributions, one or more sensor data recordings corresponding to one or more types of driving scenarios associated with the one or more safety goals; and store, as at least a portion of the test data, the one or more sensor data recordings in one or more test datasets associated with the one or more safety goals.

I. The system of paragraph H, the one or more processors further to: apply, as one or more test inputs to one or more systems or components associated with the one or more machines, the one or more sensor data recordings; obtain output data indicating one or more outputs of the one or more systems or components responsive to the one or more test inputs; and evaluate the performance of the one or more systems or components associated with the one or more machines based at least on comparing the output data with labeled ground truth data corresponding to the one or more sensor data recordings.

J. The system of any one of paragraphs H-I, wherein the determination of the quantity of the test data is based at least on performing one or more fault-tree analyses of the one or more safety goals.

K. The system of any one of paragraphs H-J, the one or more processors further to: plan, based at least on the one or more target distributions, one or more paths for one or more second machines; obtain, based at least on causing the one or more second machines to traverse the one or more paths, one or more second sensor data recordings generated using one or more sensors of the one or more second machines while traversing the one or more paths; and store, in the one or more test datasets as at least a second portion of the test data, the one or more second sensor data recordings.

L. The system of any one of paragraphs H-K, wherein the one or more sensor data recordings correspond to one or more first geographic locations that are distinguishable from one or more second geographic locations corresponding to training data used to train one or more systems or components of the one or more machines.

M. The system of any one of paragraphs H-L, wherein the anticipated driving conditions include at least one of: one or more countries the one or more machines are anticipated to operate in; one or more road types the one or more machines are anticipated to operate on; one or more weather conditions the one or more machines are anticipated to operate in; one or more times of day the one or more machines are anticipated to operate during; or one or more traffic densities the one or more machines are anticipated to operate in.

N. The system of any one of paragraphs H-M, the one or more processors further to: generate one or more simulated sensor data recordings corresponding to one or more simulations depicting the one or more types of driving scenarios; and store, as at least a second portion of the test data, the one or more simulated sensor data recordings in the one or more test datasets.

O. The system of any one of paragraphs H-N, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language model (LLMs); a system for performing operations using one or more vision language models (VLMs); a system for performing operations using one or more multi-modal language models (MMLMs); a system for performing operations using one or more vision-language-action (VLA) models; a system for using or deploying one or more inference microservices; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

P. One or more processors comprising processing circuitry to: cause one or more first machines to perform one or more operations based at least on applying test data of a safety test dataset as one or more simulated sensor inputs to one or more systems or components of the one or more first machines, wherein the safety test dataset is generated, at least, by: determining a quantity of the test data associated with validating performance of the one or more first machines with respect to one or more safety goals; determining, based at least on one or more anticipated driving conditions of the one or more first machines, one or more target distributions for the test data across the one or more anticipated driving conditions; and obtaining, for at least a portion of the test data and based at least on the quantity and the one or more target distributions, one or more sensor data recordings generated using one or more sensors of one or more second machines, the one or more sensor data recordings corresponding to one or more types of driving scenarios associated with the one or more safety goals.

Q. The one or more processors of paragraph P, wherein the determining of the quantity of the test data is based at least on performing one or more fault-tree analyses of the one or more safety goals.

R. The one or more processors of any one of paragraphs P-Q, wherein the obtaining of the one or more sensor data recordings comprises: planning, based at least on the one or more target distributions, one or more paths for the one or more second machines; and causing the one or more second machines to traverse the one or more paths, wherein the one or more sensor data recordings are generated using the one or more sensors of the one or more second machines while traversing the one or more paths.

S. The one or more processors of any one of paragraphs P-R, wherein at least a portion of the safety test dataset is generated, at least, by: generating one or more simulated sensor data recordings corresponding to one or more simulations depicting the one or more types of driving scenarios; and storing, as at least the portion of the safety test dataset, the one or more simulated sensor data recordings and corresponding ground truth data.

T. The one or more processors of any one of paragraphs R-S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language model (LLMs); a system for performing operations using one or more vision language models (VLMs); a system for performing operations using one or more multi-modal language models (MMLMs); a system for performing operations using one or more vision-language-action (VLA) models; a system for using or deploying one or more inference microservices; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

1. A method comprising:
determining, based at least on one or more failure thresholds associated with one or more safety goals of a machine, one or more quantities of test data associated with statistically validating performance of one or more systems or components of the machine with respect to the one or more safety goals;
determining, based at least on information obtained from one or more operational usage models indicative of one or more anticipated driving conditions of the machine, one or more target distributions for the test data across the one or more anticipated driving conditions;
obtaining, for the test data and based at least on the one or more quantities and the one or more target distributions, at least one or more sensor data recordings corresponding to one or more types of driving scenarios associated with the one or more safety goals;
generating, based at least on one or more labeling specifications associated with the one or more safety goals, labeled ground truth data corresponding to the one or more sensor data recordings;
storing, as one or more test datasets, at least the one or more sensor data recordings and the labeled ground truth data; and
causing the machine to perform one or more planning or control operations based at least on applying at least a portion of the one or more sensor data recordings of the one or more test datasets as one or more simulated sensor inputs to the one or more systems or components of the machine.

2. The method of claim 1, further comprising:
applying, as one or more test inputs to the one or more systems or components of the machine, the one or more sensor data recordings;
obtaining output data indicating one or more control operations performed by the one or more systems or components of the machine responsive to the one or more test inputs; and
evaluating the performance of the one or more systems or components of the machine based at least on comparing the output data with the labeled ground truth data.

3. The method of claim 1, wherein the determining of the one or more quantities of the test data is based at least on performing one or more fault-tree analyses of the one or more safety goals.

4. The method of claim 1, wherein the obtaining of the one or more sensor data recordings comprises:
defining, based at least on the one or more target distributions, one or more paths for one or more second machines to follow through one or more environments; and
causing the one or more second machines to traverse the one or more paths, wherein one or more sensors of the one or more second machines generate at least a portion of the one or more sensor data recordings while traversing the one or more paths.

5. The method of claim 1, wherein the one or more sensor data recordings correspond to one or more first geographic locations that are distinguishable from one or more second geographic locations corresponding to training data used to train the one or more systems or components of the machine.

6. The method of claim 1, wherein the one or more anticipated driving conditions of the machine include at least one of:
one or more countries the machine is anticipated to operate in,
one or more road types the machine is anticipated to operate on,
one or more weather conditions the machine is anticipated to operate in,
one or more times of day the machine is anticipated to operate during, or
one or more traffic densities the machine is anticipated to operate in.

7. The method of claim 1, further comprising:
generating, for at least a portion of the test data and based at least on the one or more target distributions, one or more simulated sensor data recordings corresponding to one or more simulated driving scenarios associated with the one or more safety goals; and
storing, in the one or more test datasets, the one or more simulated sensor data recordings and corresponding ground truth data.

8. A system comprising one or more processors to:
determine a quantity of test data sufficient to validate performance of one or more machines with respect to one or more safety goals;
determine, based at least on anticipated driving conditions for the one or more machines, one or more target distributions for the test data across the anticipated driving conditions;
obtain, based at least on the quantity and the one or more target distributions, one or more sensor data recordings corresponding to one or more types of driving scenarios associated with the one or more safety goals;
store, as at least a portion of the test data, the one or more sensor data recordings in one or more test datasets associated with the one or more safety goals; and
cause at least one machine of the one or more machines to perform one or more operations based at least on applying at least a portion of the one or more sensor data recordings as one or more simulated sensor inputs to one or more systems or components of the at least one machine.

9. The system of claim 8, the one or more processors further to:
apply, as one or more test inputs to one or more systems or components associated with the one or more machines, the one or more sensor data recordings;
obtain output data indicating one or more outputs of the one or more systems or components responsive to the one or more test inputs; and
evaluate the performance of the one or more systems or components associated with the one or more machines based at least on comparing the output data with labeled ground truth data corresponding to the one or more sensor data recordings.

10. The system of claim 8, wherein the determination of the quantity of the test data is based at least on performing one or more fault-tree analyses of the one or more safety goals.

11. The system of claim 8, the one or more processors further to:
plan, based at least on the one or more target distributions, one or more paths for one or more second machines;
obtain, based at least on causing the one or more second machines to traverse the one or more paths, one or more second sensor data recordings generated using one or more sensors of the one or more second machines while traversing the one or more paths; and
store, in the one or more test datasets as at least a second portion of the test data, the one or more second sensor data recordings.

12. The system of claim 8, wherein the one or more sensor data recordings correspond to one or more first geographic locations that are distinguishable from one or more second geographic locations corresponding to training data used to train one or more systems or components of the one or more machines.

13. The system of claim 8, wherein the anticipated driving conditions include at least one of:
one or more countries the one or more machines are anticipated to operate in;
one or more road types the one or more machines are anticipated to operate on;
one or more weather conditions the one or more machines are anticipated to operate in;
one or more times of day the one or more machines are anticipated to operate during; or
one or more traffic densities the one or more machines are anticipated to operate in.

14. The system of claim 8, the one or more processors further to:
generate one or more simulated sensor data recordings corresponding to one or more simulations depicting the one or more types of driving scenarios; and
store, as at least a second portion of the test data, the one or more simulated sensor data recordings in the one or more test datasets.

15. The system of claim 8, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language model (LLMs);
a system for performing operations using one or more vision language models (VLMs);
a system for performing operations using one or more multi-modal language models (MMLMs);
a system for performing operations using one or more vision-language-action (VLA) models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

16. One or more processors comprising processing circuitry to:
cause one or more first machines to perform one or more operations based at least on applying test data of a safety test dataset as one or more simulated sensor inputs to one or more systems or components of the one or more first machines, wherein the safety test dataset is generated, at least, by:
determining a quantity of the test data associated with validating performance of the one or more first machines with respect to one or more safety goals;
determining, based at least on one or more anticipated driving conditions of the one or more first machines, one or more target distributions for the test data across the one or more anticipated driving conditions; and
obtaining, for at least a portion of the test data and based at least on the quantity and the one or more target distributions, one or more sensor data recordings generated using one or more sensors of one or more second machines, the one or more sensor data recordings corresponding to one or more types of driving scenarios associated with the one or more safety goals.

17. The one or more processors of claim 16, wherein the determining of the quantity of the test data is based at least on performing one or more fault-tree analyses of the one or more safety goals.

18. The one or more processors of claim 16, wherein the obtaining of the one or more sensor data recordings comprises:
planning, based at least on the one or more target distributions, one or more paths for the one or more second machines; and
causing the one or more second machines to traverse the one or more paths, wherein the one or more sensor data recordings are generated using the one or more sensors of the one or more second machines while traversing the one or more paths.

19. The one or more processors of claim 16, wherein at least a portion of the safety test dataset is generated, at least, by:
generating one or more simulated sensor data recordings corresponding to one or more simulations depicting the one or more types of driving scenarios; and
storing, as at least the portion of the safety test dataset, the one or more simulated sensor data recordings and corresponding ground truth data.

20. The one or more processors of claim 16, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language model (LLMs);
a system for performing operations using one or more vision language models (VLMs);
a system for performing operations using one or more multi-modal language models (MMLMs);
a system for performing operations using one or more vision-language-action (VLA) models;
a system for using or deploying one or more inference microservices;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
